(19) United States
(12) Patent Application Publication
(10) Pub. No.: US 2014/0156282 A1
(43) Pub. Date: Jun. 5, 2014

(54) METHOD AND SYSTEM FOR CONTROLLING TARGET APPLICATIONS BASED UPON A NATURAL LANGUAGE COMMAND STRING

(71) Applicant: MAXWELL WORTHINGTON, LLC, New Orleans, LA (US)

(72) Inventors: Mark Madere, New Orleans, LA (US); Albert Sunseri, New York, NY (US)

(21) Appl. No.: 14/081,995

(22) Filed: Nov. 15, 2013

Related U.S. Application Data
(60) Provisional application No. 61/727,026, filed on Nov. 15, 2012.

(51) Int. Cl. G10L 21/06

(52) U.S. Cl. CPC G10L 21/06
USPC 704/275

(57) ABSTRACT

Disclosed is a method and system for controlling applications based upon a natural language command string. Embodiments may utilize skills of expert users of one or more target applications to create a domain specific language definition. An embodiment may then permit a less sophisticated user to control target applications using natural language command strings. An embodiment may process the natural language command string to obtain the complex code and/or configurations necessary to control the target applications. During the processing, each word (i.e., token/element) of the natural language command string is processed and compared with the domain specific language definition, which provides cardinal, order-of-operation, and other applicable data for each token/element, as well as translation procedures (i.e., jobs) that when run for each token/element provide the translation for the natural language command string. An embodiment may also permit a job to create new grammar to be evaluated recursively with additional jobs.

### CROSS REFERENCE TO RELATED APPLICATIONS

This application is based upon and claims priority to: U.S. provisional application Ser. No. 61/727,026, filed Nov. 15, 2012, entitled “Using Natural Language and an Automation Translator to Command Applications,” all of which is specifically incorporated herein by reference for all that it discloses and teaches.

### BACKGROUND OF THE INVENTION

In accord with the well-known Moore's Law, the computation power of computers has roughly doubled every two years. The communications speed and availability has also increased in speed and bandwidth in a similar fashion over time. As the computation power of a computers and computer networking/communications has progressed the computing power available to a user has increased tremendously. With the availability of so much computing power both local and available over shared networks, the applications running on the computers has likewise become more powerful and sophisticated. Many software applications, particularly the back office applications (i.e., e-mail servers, web information servers, etc.), available to small to large size businesses have become increasingly powerful to harness the increased availability of computing power. However, as the software applications become more powerful, the software application often becomes increasingly complex to setup and maintain, often requiring an expert to perform the setup and maintenance tasks necessary for the software applications to perform optimally.

### SUMMARY OF THE INVENTION

An embodiment of the present invention may comprise a computerized method for controlling at least one target application running on a computer system based upon a natural language command string from a user, the computerized method comprising: receiving at the computer system the natural language command string from the user; parsing by the computer system the natural language command string to create a list of tokens contained in the natural language command string, each token of the list of tokens being a word or defined phrase in the natural language command string; determining by the computer system a symbol and cardinals for each token in the list of tokens as a function of an analysis of a domain specific language definition stored on the computer system, the symbol being representative of the token and the cardinals being parameters that describe a usage and an order-of-operation for each token; creating by the computer system in a semantic manifold an element for each token in the list of tokens such that the semantic manifold contains a list of elements corresponding to the list of tokens, the element being a data structure that stores the symbol and the cardinals of a token, creating by the computer system a queue of jobs based on elements in the semantic manifold as a function of an order-of-operation and element prescriptions in the domain specific language definition and the cardinals of each element in the list of elements of the semantic manifold, a job being at least one procedure defined in the domain specific language definition declaring operations to create a translation of an element into code and/or configurations that controls the at least one target application; selecting by the computer system a first job in the queue of jobs as a selected job based on the order-of-operations and element prescriptions in the domain specific language definition; executing by the computer system the selected job in order to create a command translation built from execution of each job in the queue of jobs; determining by the computer system if the list of elements in the semantic manifold has changed; when the list of elements in the semantic manifold is determined to be changed, returning operation by the computer system to the step of creating the queue of jobs based on the list of elements as the function of the order-of-operation and element prescriptions in the domain specific language definition and the cardinals of each element in the list of elements of the semantic manifold; when the list of elements in the semantic manifold is determined not to be changed, determining by the computer system if the selected job is a last job in the job queue; when the selected job is determined to not be a last job in the job queue, selecting by the computer system a next job in the queue of jobs as the selected job based on the order-of-operations and element prescriptions in the domain specific language definition and returning operation by the computer system to the step of executing the selected job; when the selected job is determined to be the last job in the job queue, processing the command translation to create command code and/or configurations that control operation of the at least one target application; and executing the command code and/or configurations to control operation of the at least one target application.

An embodiment of the present invention may further comprise a natural language translator system that controls at least one target application based upon a natural language command string from a user, the natural language translator system comprising: a natural language command string receive subsystem that receives the natural language command string from the user; a parse subsystem that parses the natural language command string to create a list of tokens contained in the natural language command string, each token of the list of tokens being a word or defined phrase in the natural language command string; a symbol and cardinal determination subsystem that determines a symbol and cardinals for each token in the list of tokens as a function of an analysis of a domain specific language definition stored on the computer system, the symbol being representative of the token and the cardinals being parameters that describe a usage and an order-of-operation for each token; an element creation subsystem that creates in a semantic manifold an element for each token in the list of tokens such that the semantic manifold contains a list of elements corresponding to the list of tokens, the element being a data structure that stores the symbol and the cardinals of a token, a job queue creation subsystem that creates a queue of jobs based on elements in the semantic manifold as a function of an order-of-operation and element prescriptions in the domain specific language definition and the cardinals of each element in the list of elements of the semantic manifold, a job being at least one procedure defined in the domain specific language definition declaring operations to create a translation of an element into code and/or configurations that controls the at least one target application; a first job selection subsystem that selects a first job in the queue of jobs as a selected job based on the order-of-operations and element prescriptions in the domain specific language definition; a job execution subsystem that executes the selected job in order to create a command translation built from execution of each job in the queue of jobs; a semantic manifold change detection subsystem that determines if the list of elements in the semantic manifold has changed and, when the list of elements in the semantic manifold is determined to be changed, returns operation to the job queue creation subsystem, and, when the list of elements in the semantic manifold is determined not to be changed, sends operation to a last job determination subsystem; the last job determination subsystem that determines if the selected job is a last job in the job queue and, when the selected job is determined to not be a last job in the job queue, sends operation to a select next job determination subsystem, and, when the selected job is determined to be the last job in the job queue sends operation to a command translation processing subsystem; the next job determination subsystem that selects a next job in the queue of jobs as the selected job based on the order-of-operations and element prescriptions in the domain specific language definition and returns operation by the computer system to the job execution subsystem; the command translation processing subsystem that processes the command translation to create command code and/or configurations that control operation of the at least one target application; and a command execution subsystem that executes the command code and/or configurations to control operation of the at least one target application.

### BRIEF DESCRIPTION OF THE DRAWINGS

In the drawings,

FIG. 1 is a schematic illustration of the back office applications server system architecture.

FIG. 2 is a flow chart of operation of an embodiment.

FIG. 3 is a flow chart of a system overview of a particular embodiment including enhanced error checking and system interaction.

FIG. 4 is a flow chart of a worker overview for the particular embodiment including enhanced error checking and system interaction.

FIG. 5 is a flow chart of the process to parse tokens and create a semantic manifold for the particular embodiment including enhanced error checking and system interaction.

FIG. 6 is a flow chart of the process to check sentence grammar for the particular embodiment including enhanced error checking and system interaction.

FIG. 7 is a flow chart of the process to parse the semantic manifold to create the job queue for the particular embodiment including enhanced error checking and system interaction.

FIG. 8 is a flow chart of the process to execute jobs and create the command translation for the particular embodiment including enhanced error checking and system interaction.

FIG. 9 is a flow chart of the process to validate a command translation for the particular embodiment including enhanced error checking and system interaction.

FIG. 10 is a flow chart of the process for processing the command translation for the particular embodiment including enhanced error checking and system interaction.

FIG. 11 is a flow chart of the process for the clean process translation function for the particular embodiment including enhanced error checking and system interaction.

FIG. 12 is a flow chart of the process for the display process translation function for the particular embodiment including enhanced error checking and system interaction.

FIG. 13 is a flow chart of the process for the subprocess process translation function for the particular embodiment including enhanced error checking and system interaction.

FIG. 14 is a flow chart of the process for the input process translation function for the particular embodiment including enhanced error checking and system interaction.

FIG. 15 is a diagrammed series of steps view that shows the overall use of a particular embodiment.

FIG. 16 is a diagrammed series of steps view that shows the creation of the functional parts of the system of the particular embodiment.

FIG. 17 is a diagrammed series of steps view that shows creation of the fuzzy personal programming language of the particular embodiment.

FIG. 18 is a diagrammed series of steps view that shows the creation of the prescription of the particular embodiment.

FIG. 19 is a diagrammed series of steps view that shows the creation of the prescription storage components of the particular embodiment.

FIG. 20 is a diagrammed series of steps view that shows the natural language command application processing of a fuzzy input created by the system in order to perform a function of the particular embodiment.

### DETAILED DESCRIPTION OF THE EMBODIMENTS

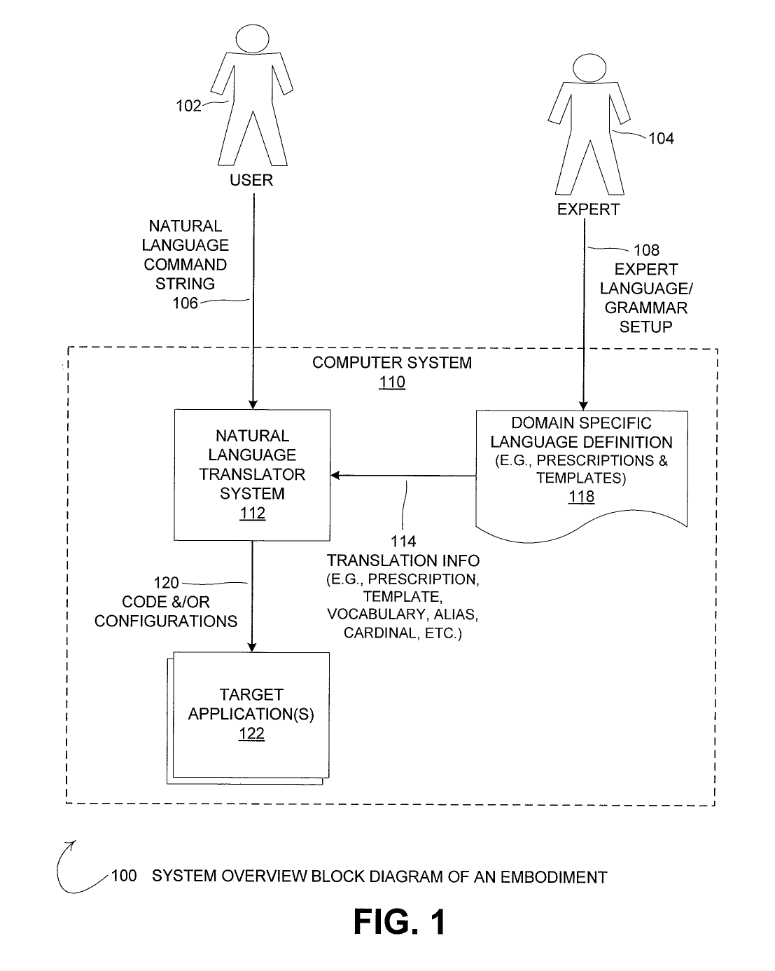

FIG. 1 is a system overview block diagram 100 of an embodiment. In the embodiment shown in FIG. 1, there is a computer system 110 that performs the operations of the natural language translator system 112 and the target application(s) 122. The computer system 110 also stores the information in the domain specific language definition 118. The domain specific language definition 118 provides the expert 104 analysis and grammar setup 108 to define the relationship between a natural language string 106 from a user 102 (i.e., nothing more than a semi-skilled person with regard to computer data entry is required) and the code and/or configurations 120 that are actually necessary to control the target applications 122. The natural language translator system obtains the translation information 114 that defines how the natural language command string 106 from the user is translated to code and/or configurations for the target application(s) 122.

An embodiment may provide an automated mechanism in the natural language translator system 112 that permits a semi-skilled user, such as user 102, to perform complex interactions 120 with the one or more applications 122 by taking advantage of expertise of one or more experts 104 that setup the grammar and syntax rules 108 in the domain specific language definition 118 for a natural language command string 106 to translate to the code and/or configurations 120 that actually control the target application(s) 122. An embodiment may permit the semi-skilled user 102 to create command strings 106 that closely resemble the natural speaking language of the semi-skilled user 102. The command string 106, or natural language command string 106, created by the semi-skilled user 102 may then substitute for much of the complex interaction with the target application(s) 122 necessary for proper operation. In other words, the target application(s) are controlled by way of human input 106 in the form of sentences 106 (i.e., user 102 entered natural language command strings 106). The human input 106 may be provided to an automated natural language translator system, which will attempt to create a translation of the natural language command string 106 into the code &/or configurations that actually control the target application(s) 122. If a natural language command is understood by the natural language translator system using the domain specific language definition 118, a translation to the code &/or configurations 120 associated with the natural language command string 112 will be presented to the target application(s) 122 to perform the desired task or tasks. Thus, an embodiment may allow a semi-skilled user(s) 102 to accurately create complex computer code and configurations for the target application(s) 122 without the need to directly consult with an expert 104.

The user 102 may be any entity capable of creating the natural language command string 106. While it is typically expected that the user 102 is a human, and might more commonly be semi-skilled rather than an expert 104, the user 102 may be the expert 104 looking for a faster way to send commands to the target application(s). Further, the user 102 may not be human at all, but may be some type of apparatus and/or software that is capable of creating and sending the natural language command string 106 to the natural language translator system 112.

A human user 102 may create and transmit the natural language command string 106 to the natural language translator system using any available data entry system capable of creating the natural language command string 106. For instance, a standard keyboard and graphical user interface may be utilized to enter the natural language command string 106. Alternatively, for a computer system having a touch screen, the user may enter the data using the touch screen function of the graphical user interface. Further, a computer system 110 may have an attached microphone that can pick up words spoken by the user 102 and apply a voice-to-text conversion software to create the text of the natural language command string 106 to send to the natural language translator system 112.

The expert 104 may be one or more people who have expertise in the operation of the target application(s). In fact, it may be desirable to have experts 104 continually update the domain specific language definition 118 in order to make the domain specific language definition more robust and capable for new applications 122 and/or application 122 features.

The expert language/grammar setup information 108 may be comprised of any means of delivering the rules, prescriptions, cardinals, markers, etc. necessary to define a translation between the natural language command string 106 into code and/or configurations that actually control the target application(s) 122 to the domain specific language definition 118. The domain specific language definition 118 may be stored on the computer system 110 in text files, binary files, table files, or other file types. Additionally, a database (object oriented, relational, flat, or otherwise) may also be used as a storage mechanism for the domain specific language definition 118. Further, a combination of files, databases, and/or other storage means may be used to store the domain specific language definition 118 as desired by an embodiment designer.

The computer system 110 may be comprised of one or a plurality of computers, computing devices, and/or computer readable storage media. Each individual entity (i.e., the natural language translator system 112, the domain specific language definition 118, and/or the target application(s) 122) may operate on different individual computers within the overall computer system 110. Further, the entities (112, 118, and 122) may each be split up across several computers in a computer system. For instance, the natural language translator system 112 may be split up into client and server sections with the client acting as the user interface on remote machines, with the main processing occurring at the server portion on a server machine or server cluster. Similar client/server features may also be present in the target application(s) 122. The domain specific language definition may be stored on a single computer readable storage device, or may be spread across several computer readable storage devices. If there is a plurality of computers, computing devices, and/or computer readable storage media in the computer system 110, the individual devices are necessarily operatively coupled together so that the appropriate communication of data may take place.

For the expert(s) 104 to create the domain specific language definition 118, the experts may analyze the target application(s) 122 and the grammar syntax of the primary language of the user 102. For each application 122 the process of creating the domain specific language definition may begin with an analysis of the commands 120 used to control the application 122. The commands 120 to control the application may be native to the application 122 and/or used by an Application Protocol Interface (API). This analysis should be performed by experts 104 that are highly-skilled and proficient at controlling an application 122 on a level below natural language.

The purpose of the analysis of the application 122 commands 120 may be to develop a strategy for establishing a prescriptive grammar that closely resembles the natural speaking language grammar of the user 102. Following a strategy of using vocabulary and syntax specific to a particular application 122, the highly-skilled expert 104 may create a semi-formal grammar. This semi-formal grammar, along with the natural language translator system 112, may create an interface to the application(s) 122 using sentences (i.e., natural language command strings 106) based on the natural language of the user 102. The established semi-formal grammar may be used by human and/or machine users 102 in order to compose imperative sentences 106 that express commands. Typically, the imperative command sentences 106 may also be comprehended by humans not skilled with the application(s) 122.

When the expert 104 creates grammatical rules for an application 122, various embodiments typically should respect one rule. The one rule to respect involves the concept of “intrinsic” versus “extrinsic” when establishing the order of certain elements of a sentence 106 (note that below in this document the element of the sentence is substantially a token that is then used as part of the basis to create an element data structure reflective of the token/word/phrase found in the sentence 106 (i.e., the natural language command string 106). An element of a sentence 106 may be a single word or the element may be a defined phrase of two or more words. Each word or phrase used in the natural language command string 106 will either be intrinsic to the application 122 or extrinsic and external to the application 122. Some, but not all, intrinsic elements include reserved words, commands, and command options. Extrinsic elements relate to the external environment and are not found explicitly in the syntactical structure of the application(s) 122. Intrinsic elements which are modified by extrinsic elements appear in the order intrinsic, extrinsic. The order may be swapped to be extrinsic, intrinsic to accommodate different user native spoken languages if that is the correct format for the spoken language of the user. However, the order should be consistent for the entire domain specific language. It may also be necessary to adjust the jobs class to be extended/replaced with jobs that process right to left instead of left to right.

Once a grammar has been established for the domain specific language definition 118, the natural language translator system 112 may be programmed to translate human input of the natural language command string 106 into commands 120 for the application(s) 122. A natural language translator system 112 may be programmed to interact with the domain specific language definition 118 structure implemented by the experts 104. For instance, in one embodiment the domain specific language definition may provide two libraries of data, a prescription library and a template library. The prescription library of the embodiment may provide the natural language translator system 112 instructions for parsing and manipulating the natural language command string 106 while the template library may provide the natural language translator system 112 computer code and configurations used to generate output in the form of commands 120 for the application(s) 122.

For an embodiment with a template library in the domain specific language definition 118, the template library may contain a collection of templates stored as text files. The templates may contain computer code and configurations used to control an application. The templates may also contain placeholders, also called markers, which will be replaced by the natural language translator system 112 with extrinsic elements from natural language command string 106. The templates may also contain partial segments of computer code and configurations. The segments of computer code and configurations may be reused for multiple purposes within an application 122 and/or a command 120. A template may also be used several times in one natural language command string 106. Additionally, the output of one template may be used to replace a marker of any template to permit recursive building of language structure such as a natural language command string 106 to create a web information server providing output to additional templates that may involve sub-processes necessary to create the web service not originally defined in the natural language command string 106.

The reason for creating template files with certain specific terms as placeholders/markers for an embodiment may be to facilitate the translation of natural language command string 106 into computer code 120. One skilled in the art will understand that both human language and computer code are governed by grammatical structures and rules. The template segmentation may be directed by human linguistic structures, general grammatical rules and the constraints of the control processes for an application 122. This template segmentation allows a finite number of functions to successfully modify the natural language command string 106 as part of the process of translating the natural language command string 106 into computer code 120 for an application 122.

For an embodiment with a prescription library in the domain specific language definition 118, the prescription library may be stored as a text file containing prescriptions for symbols that may occur in the natural language command string 106 or as markers (i.e., placeholders) located in templates. Prescriptions may instruct the natural language translator system 112 to modify the natural language command string 106, replace markers in templates, or perform other tasks required to accurately perform a translation.

For an embodiment with a prescription library and a template library in the domain specific language definition 118, the natural language command string 106 input may be translated according to an order-of-operations. The order-of-operations may be determined by the arrangement of the prescriptions in the prescription library. The natural language translator system 112 may parse the prescription library from beginning to end creating a prescription list by extracting each cardinal of each prescription in the prescription library. Duplicate entries may then be removed from the prescription list. The result is a series of symbol types which may define an order in which symbols from the natural language command string 106 will be manipulated by the natural language translator system 112.

For an embodiment with a prescription library in the domain specific language definition 118, when the prescription library is created care should be taken to group prescriptions by cardinal. The cardinal groups may then be arranged in an order that reflects a sequence in which instructions should be processed by the natural language translator system 112. For instance, if a prescription A requires output from a prescription B, then prescription B should be in a group above the group containing prescription A.

Alternatively, the order-of-operation may be stored in a configuration file for each domain specific language, thus, reducing the chance for breaking the order-of-operation caused by a misplaced prescription, and allowing for prescriptions to be written in a way that makes more sense to the expert (e.g. alphabetically).

For an embodiment with a prescription library in the domain specific language definition 118, jobs that declare procedures for the natural language translator system 112 may be a part of a prescription in the prescription library. Each job entry in a prescription may represent a function or another specific processing object. Each job function may modify the tokens passed to the function such that the output may need to be further translated into language that an application 122 may execute. For the embodiment, the modification of the modification of the tokens passed to the function may take two basic forms, modify the natural language command string 106 input or produce an output.

In one embodiment, the natural language translator 112 may support four internal jobs. For the embodiment, jobs that are processed external to the natural language translator may be requested through a special fifth job. Finally, jobs may be called sequentially until all applicable rules of grammar in the domain specific language definition have been exhausted. This feature allows tokens/elements modified by one job to be further modified, processed, or translated by any job in the grammar of the domain specific language definition 118.

For the embodiment supporting four internal jobs, the natural language translator system 112 may include two jobs (a prefix_keys job and a split_values job) to modify the natural language command string 106 input. The job prefix_keys may be declared with a list of tokens/elements. The prefix_keys job may insert a key (i.e., the portion of a prescription that equates a symbol with a prescription) of a prescription into the natural language command string 106 input before each occurrence of a token found in a prescription list. The adding of the prescription key may be useful to convey to the natural language command translator system 112 the grammatical rule of “understood words.” The job split_values may be declared with a delimiter and a series of tokens/elements. The split_values job may modify the extrinsic token which follows the key of a prescription key in the natural language command string 106 input. The split_values job may attempt to divide an extrinsic token into its component parts using the delimiter. The number of parts after dividing should be equal to the number of tokens. Each part may be added to the natural language command string 106 input preceded by a token.

For the embodiment supporting four internal jobs, the natural language translator system 112 may include two jobs to produce output. The job markup_value may be used to replace a single marker in a template with an extrinsic token. The markup_value job may receive two arguments. The first argument may declare how many extrinsic tokens may be assigned to an intrinsic token. The second argument may determine how many times the intrinsic token will be accepted from natural language command string 106 input. Templates which contain abstractions may be processed with the markup_value job. The job composite_values may replace all markers in a template with extrinsic tokens from the parser or the results from markup_value. The composite_values job should be the last job used during processing.

Another embodiment may have different available jobs. For instance, another embodiment may include a set of jobs including: composite( )—assign unprocessed extrinsic tokens to preceding intrinsic tokens; expand( )—copy an existing token into the semantic manifold based on later tokens and prescriptions; markup( )—used to replace a single marker in a template with an extrinsic token; pop( )—remove a token from the semantic manifold; populate( )—copy attributes from one element of the semantic manifold to another; replace( )—replace elements of the semantic manifold with other elements; and split( )—modify the extrinsic token which follows the key of a prescription key in the natural language command string 106 input. Other embodiments may add or remove embodiments as desired by the embodiment developer.

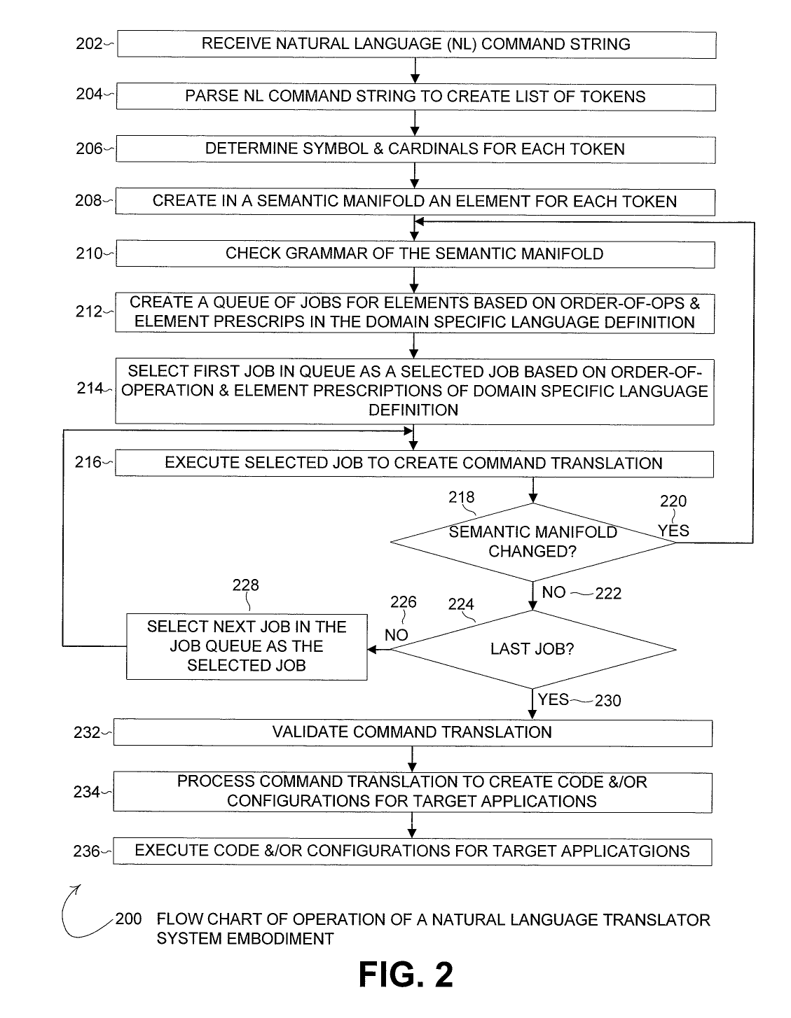

FIG. 2 is a flow chart of operation of an embodiment. At step 202, a natural language command string from a user is received at the natural language translator system. At step 204, the natural language command string is parsed to create a list of tokens contained in the natural language command string. Each token represents a word or defined phrase (i.e., two or more words that are defined together in the domain specific language definition to have a single elemental meaning) in the natural language command string. At step 206, the symbol and cardinals for each token in the list of tokens are determined. The determination of the symbol and cardinals for each token is achieved by analyzing the token against the domain specific language definition. When a token is an abbreviation of and/or is an alias of (i.e., a synonym of) a particular defined symbol in the domain specific language definition, the symbol of the token may be changed to the parent defined symbol. For instance, the term “make” may be an alias/synonym for the symbol “create” such that the token for “make” will be given the symbol “create.” Similarly, the abbreviation “mk” may be defined as “make” and also be given the symbol “create.” The cardinals of the tokens may define the symbol type, purpose, usage in grammar and order-of-operations for a token.

At step 208, in a semantic manifold an element data structure is created for each token in the list of tokens such that the semantic manifold contains a list of elements corresponding to the list of tokens. The element data structure stores the symbol and cardinals associated with the token upon which the element data structure is based. The semantic manifold holds the elements that correspond to the tokens that make up the natural language command string. The semantic manifold may have also been referred to as a “blueprint” in documents incorporated by reference in this document. At step 210, the grammar of the semantic manifold is checked for errors and appropriate error messages and error handling will be performed if any errors are detected. As step 210 is for error checking, it is possible to eliminate this step and still perform the processes of an embodiment as long as there are not errors in the semantic manifold. At step 212, a queue of jobs is created based on the elements contained in the semantic manifold as a function of the order-of-operation and element prescriptions in the domain specific language definition and the cardinals of each element in the semantic manifold. As also described above, a job is at least one procedure defined in the domain specific language definition that declares operations to create a translation of an element into code and/or configurations that controls the one or more target applications.

At step 214, a first job in the queue of jobs is selected as the “selected job” based on the order-of-operations and element prescriptions in the domain specific language definition. At step 216, the “selected job” is executed in order to create a command translation that is build from the execution of each job in the queue of jobs. That is, the execution of each job in the queue of jobs may add additional translation information to the command translation being built. Execution of a job may also alter the elements in the semantic manifold. For example, a job for an “e-mail address” symbol may have two sub-elements of different elements that should be processed to perform the operations for the “e-mail address” element. Therefore, the job of the “e-mail address” element may add the two sub-elements to the semantic manifold. This nesting may go on for several levels and, theoretically, has no limit of nesting, but an infinite nesting would most certainly result in an undesired infinite loop and care of system developers in error checking should be taken to ensure an infinite loop does not occur.

At step 218, the semantic manifold is checked to determine if there are any changes in the list of elements in the semantic manifold. If a change in the semantic manifold is detected 220 (e.g., the addition of the two sub-elements for the create element in the example described above), then the operation recursively returns to step 210 to check the grammar of the semantic manifold (or if not performing error checking operation returns to step 212 to create a queue of jobs for the elements in the semantic manifold). If no change 222 in the semantic manifold is detected at step 218, then operation proceeds to step 224. At step 224, the currently selected job is checked to determine if the currently selected job is the last job in the job queue. If the currently selected job at step 224 is not the last job in the job queue 226, operation moves to step 228. At step 228, the next job in the job queue is selected from the job queue based on the order-of-operation and element prescriptions in the domain specific language definition. From step 228, operation loops back to step 216 to execute the currently “selected job.” If the currently selected job at step 224 is the last job in the job queue 230, operation moves to step 232

At step 232, the command translation is validated to check for errors and appropriate error messages and error handling will be performed if any errors are detected. As step 232 is for error checking, it is possible to eliminate this step and still perform the processes of an embodiment as long as there are not errors in the command translation produced by the execution of the job queue. At step 234, the command translation produced by the execution of the job queue is processed to create code and/or configurations that control the target application(s). At step 236, the code and/or configurations are executed to control the operation of the target application(s).

Please note that each step in the processes described in this document (particularly the processes and/or steps of a flow chart) be implemented as a subsystem of an overall system. For the steps described above regarding the flow chart of FIG. 2, each described step may be implemented as a subsystem of the natural language translator system. For example, the receive step 202 may be implemented by a natural language command string receive subsystem with similar subsystems implementing other steps described with respect to FIG. 2 above.

Also, please note that one skilled in the art will recognize that there may be significant error checking and correction throughout the translation process to ensure that the proper actions are taken by the target application(s) and the overall system does not crash. As the error checking may cause additional confusion, only the highest level of error checking was disclosed with respect to the operation of the embodiment shown in FIG. 2. It is anticipated that a developer will take standard precaution and perform the necessary error checking to ensure proper operation even when receiving invalid inputs.

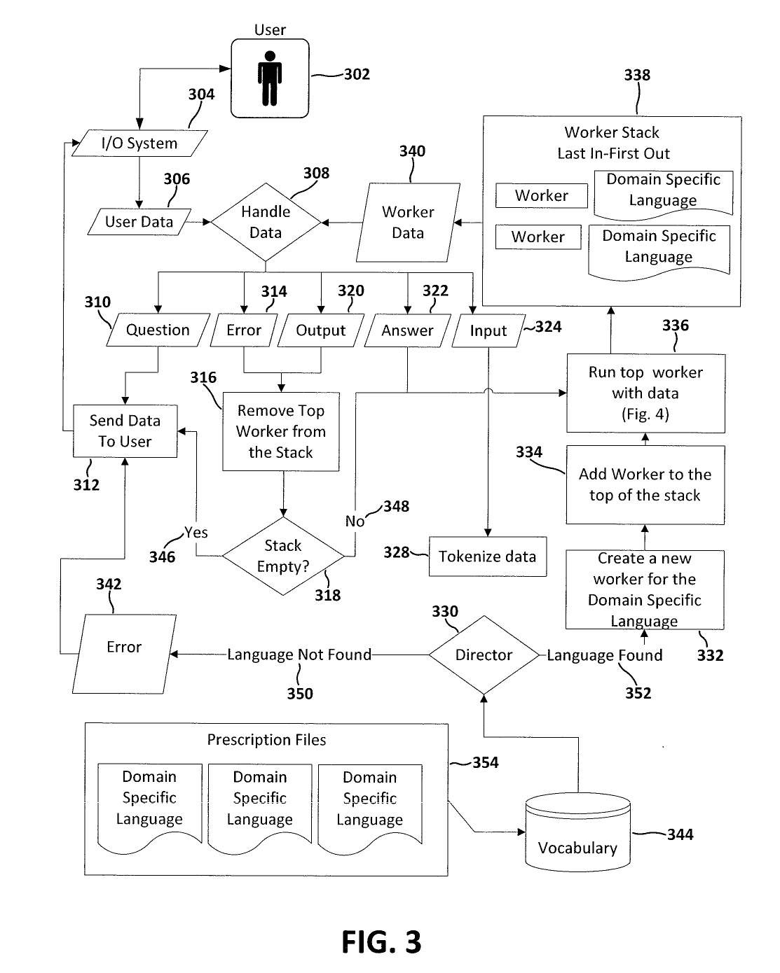

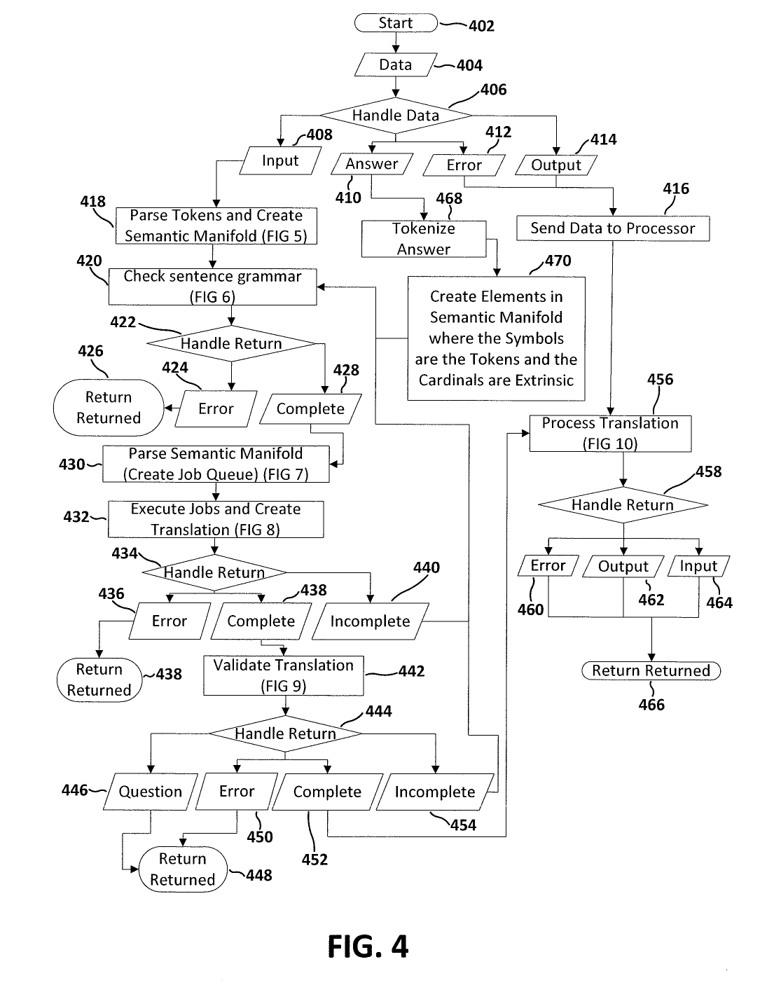

FIG. 3 is a flow chart of a system overview of a particular embodiment including enhanced error checking and system interaction. A user 302 interacts with the I/O system 304 to send user data 306 to a data handler 308. The data handler 308 decides whether the input results in a question 310, an error 314, an output 320, an answer 322, or an input 324. If data handler 308 results in a question 310, the question 310 is data to send to a user 312 that is sent to the I/O system 304 and the user 302. If data handler 308 results in an error 314 or an output 320, the top worker is removed 316 from the worker stack 338. At 318 the work stack 338 is checked to determine if the worker stack 338 is empty. If the work stack 338 is empty 346, the data is to be sent 312 to the user 302 via the I/O system 304. If the worker stack 338 is not empty 348, then operation is continued with the top worker in the stack at 336. If the data handler 308 results in an answer 322, then operation is also continued with the top worker in the stack at 336. If the data handler 308 results in an input 324, the data is tokenized at 328. At the director 330, the vocabulary 344 available via the prescription files 354 (instantiated as one or more domain specific language definition files) is interrogated. If the director 330 does not find the language 350, then an error 342 is issued, the error data is prepared at 312 to send via I/O system 304 to the user 302. If the director 330 finds the language 352, then a new worker for the domain specific language from the prescription files 354 is prepared at 332. The new worker is added to the top of the worker stack at 334 and operation is run for the top worker in the worker stack 338 at 336. The worker stack 338 is performed as a Last In First Out (LIFO) stack and worker data 340 is sent to the data handler 308 for further evaluation. More detailed operation of 336 is described in the disclosure with respect to FIG. 4.

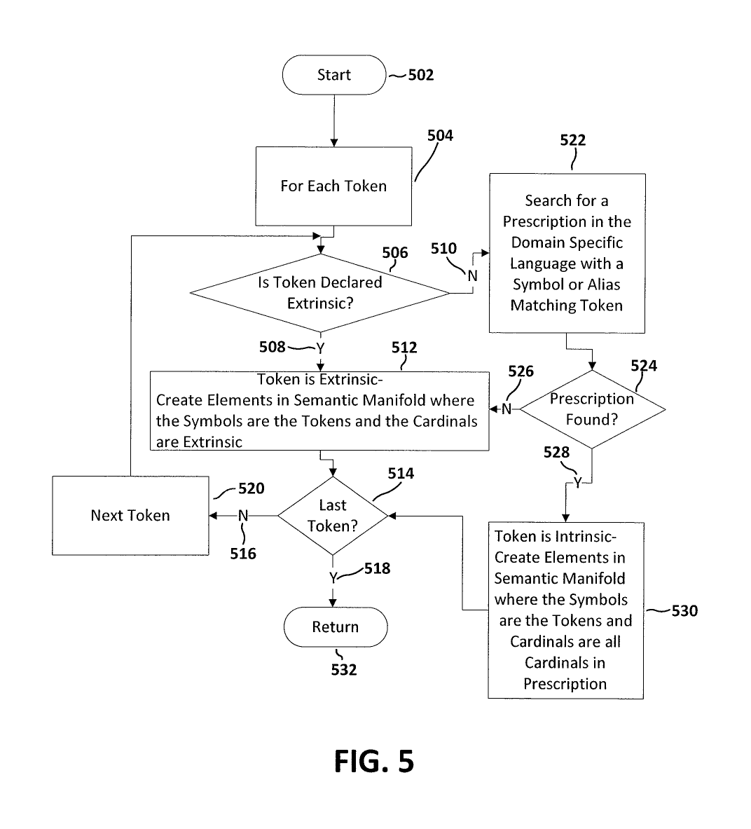

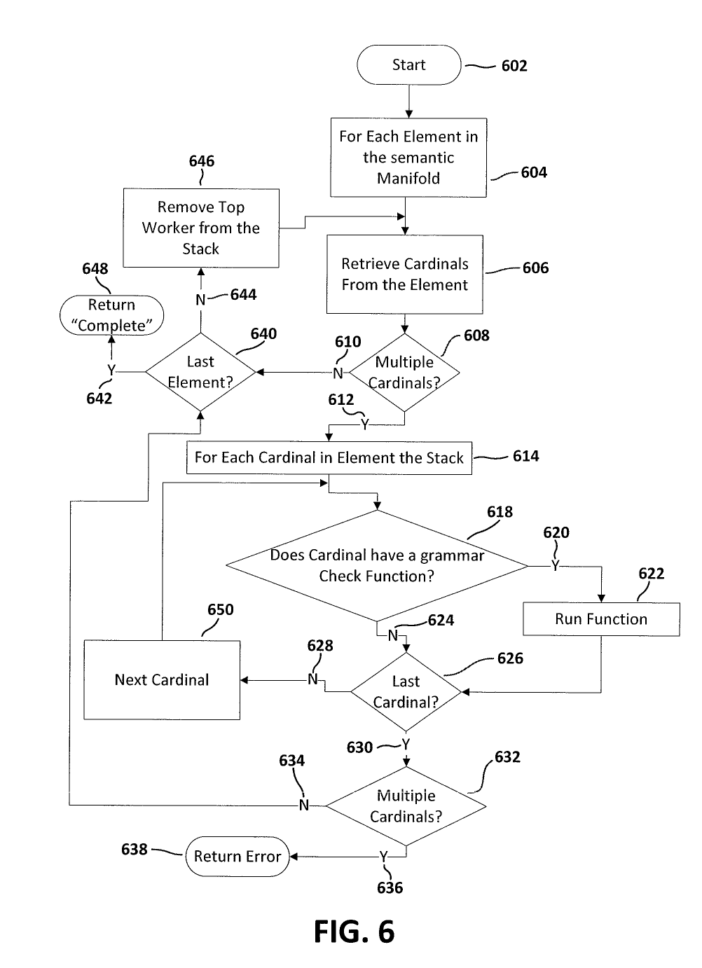

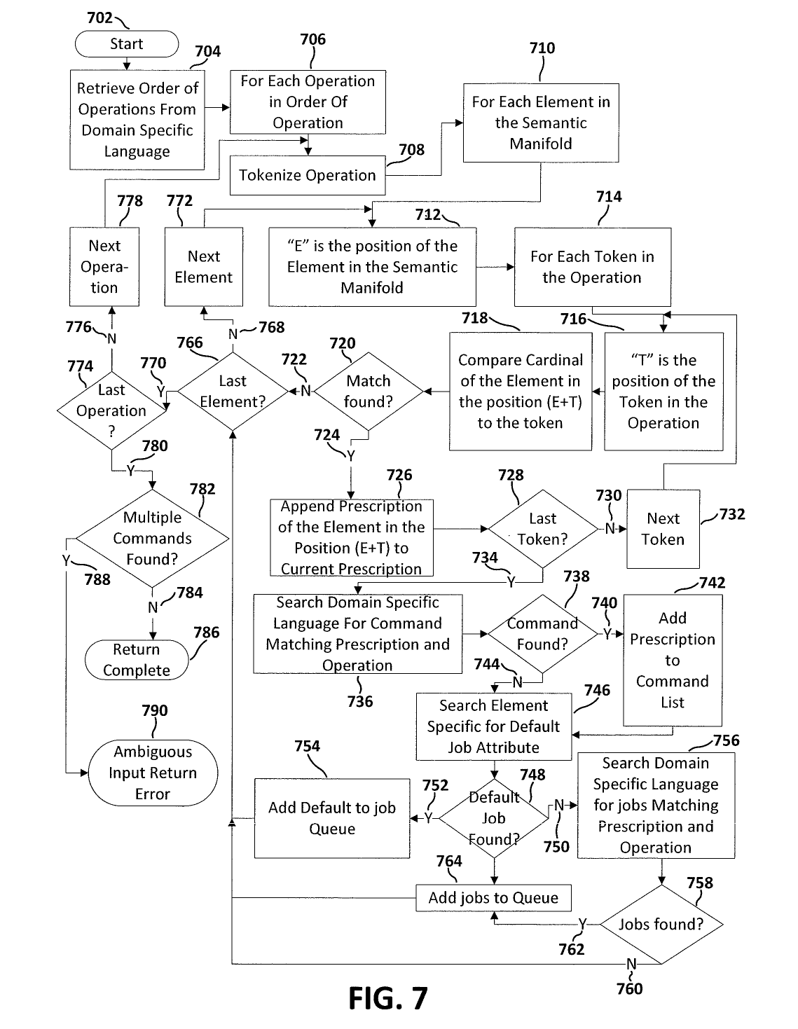

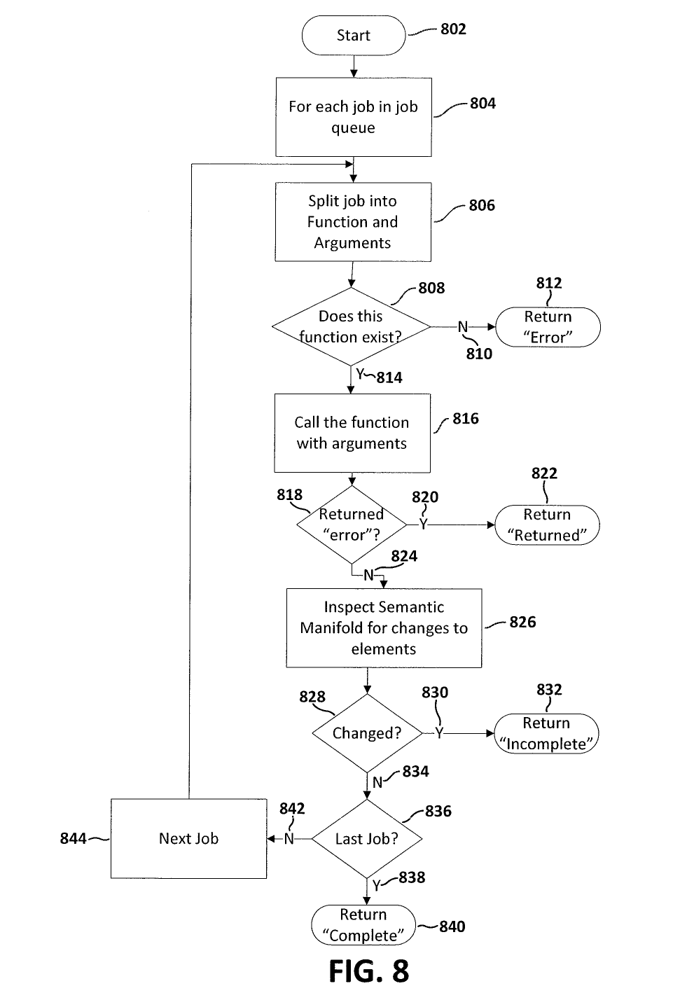

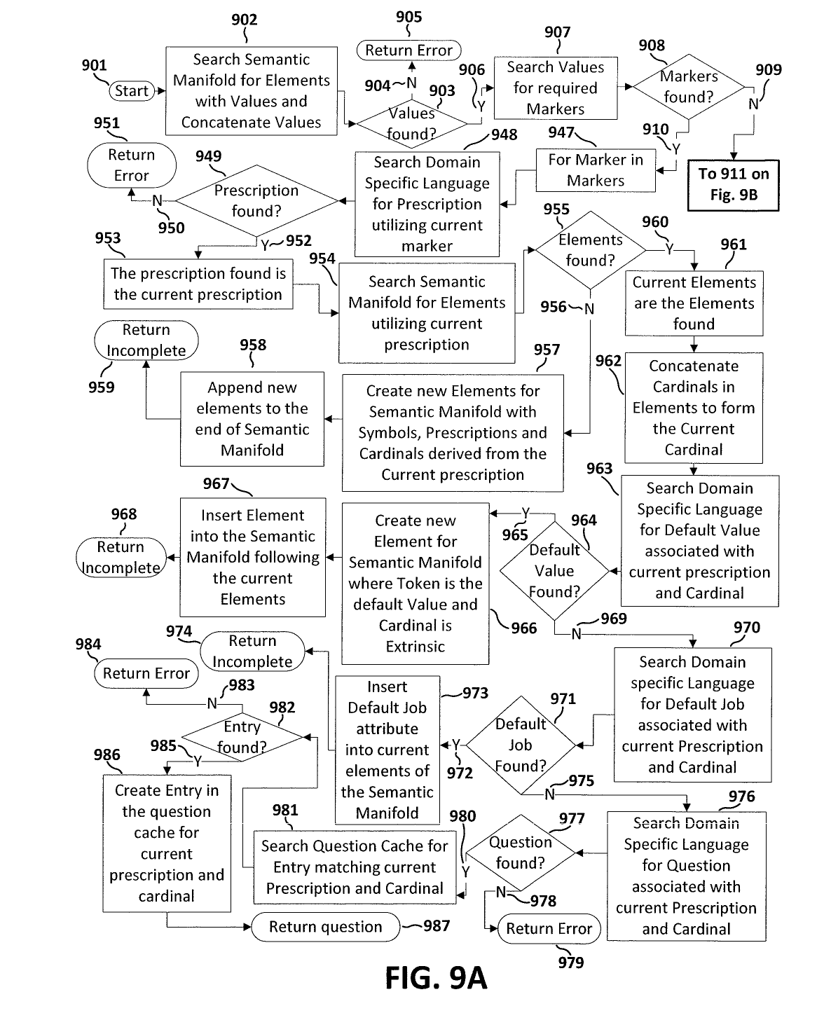

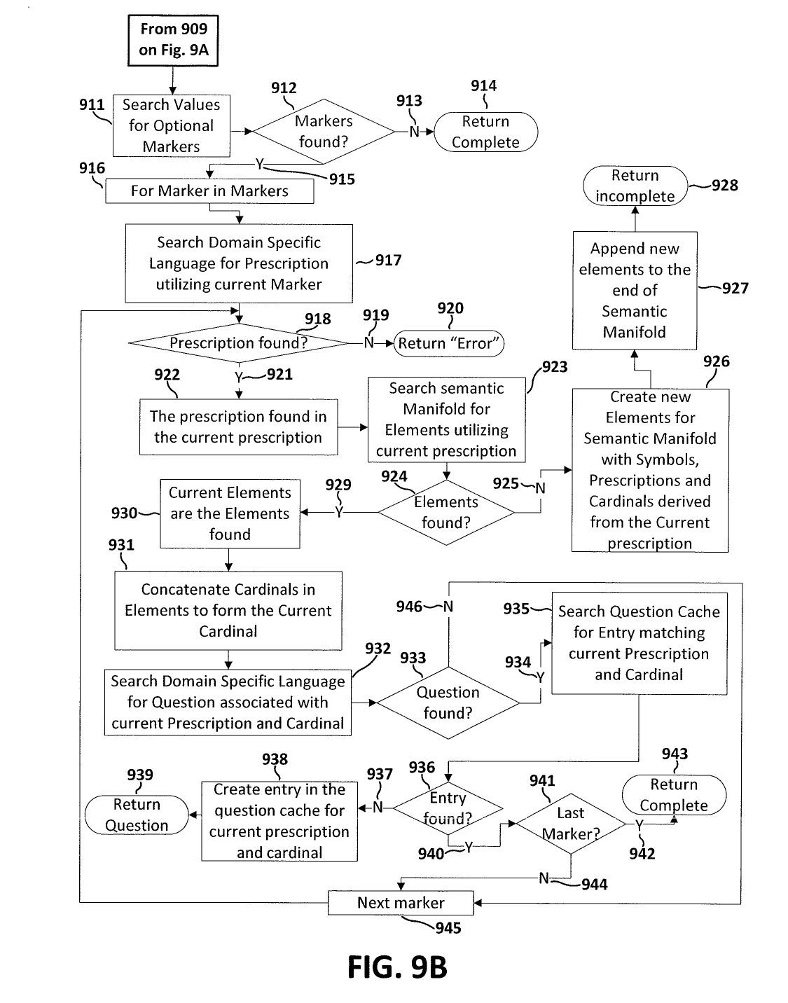

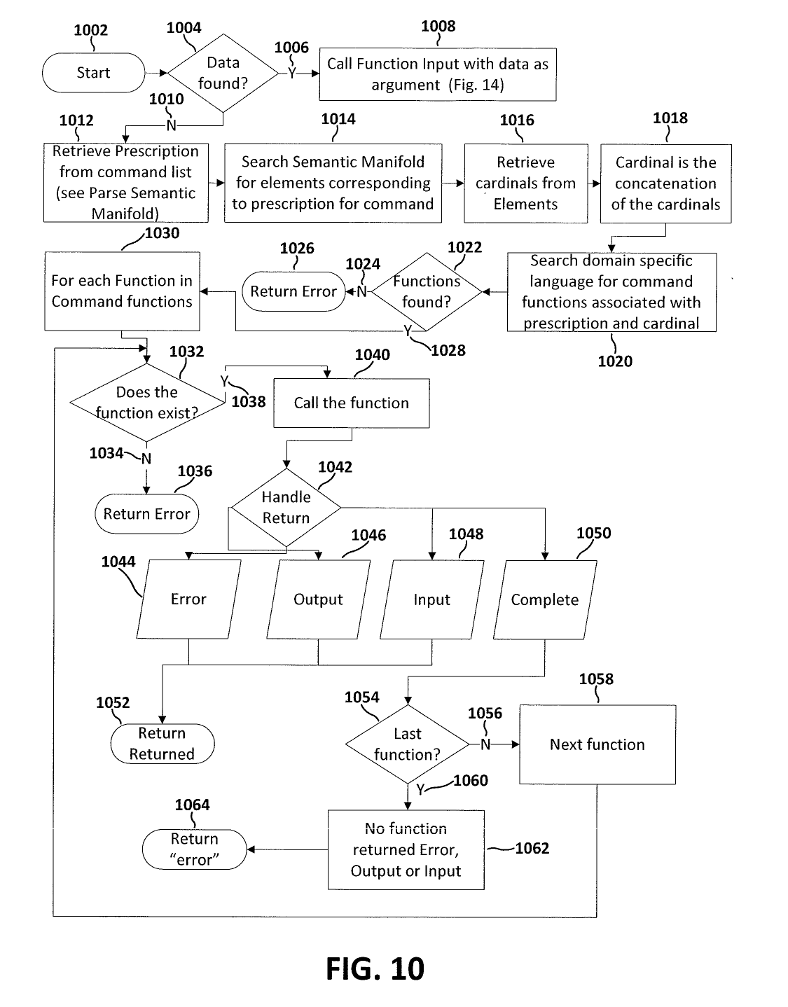

FIG. 4 is a flow chart of a worker overview for the particular embodiment including enhanced error checking and system interaction. Starting at 402, data 404 is handled by data handler 406. If data handler 406 results in an input 408, then at 418 tokens are parsed and the semantic manifold is created. From 418 the sentence grammar of the semantic manifold is checked at 420 and the return from 420 is handled at 422. If return handler 422 results in an error 424, an error is returned 426 from the worker overview. If return handler 422 results in a complete 428, the semantic manifold is parsed to create a job queue at 430. From 430, the jobs in the job queue are executed at 432 and the return from 432 is handled at 434. If the return handler 434 results in an error 436, an error is returned 438 from the worker overview. If the return handler results in an incomplete 440, then operation is returned to the semantic grammar check at 420 since the semantic manifold was changed by the job queue execution. If the return handler 434 results in a complete 438, then the translation produced by the execution of the job queue at 432 is validated at 442. The return from the translation validation 442 is handled at return handler 444. If the return handler 444 results in a question 446 or error 450, the return handler 444 result 446, 450 is returned from the worker overview at 448. If the return handler result is incomplete 454 then operation is returned to and continued at semantic grammar check 420. If the return handler 444 result is complete 452 then operation continues to process the translation at 456. The result of the process translation 456 is handled at result handler 450. The results error 460, output 462, input 464 are returned at the result of the worker overview at 466. If the data handler 406 results in an answer 410, then the answer is tokenized at 418 and the elements of the answer are created in the semantic manifold at 470. If the result of data handler 406 is an error 412 or an output 414, the data is sent to a data processor at 416 and what translation exist is performed at 456. More detailed operation of 418 is described in the disclosure with respect to FIG. 5. More detailed operation of 420 is described in the disclosure with respect to FIG. 6. More detailed operation of 430 is described in the disclosure with respect to FIG. 7. More detailed operation of 432 is described in the disclosure with respect to FIG. 8. More detailed operation of 442 is described in the disclosure with respect to FIG. 9. More detailed operation of 456 is described in the disclosure with respect to FIG. 10.

FIG. 5 is a flow chart of the process to parse tokens and create a semantic manifold for the particular embodiment including enhanced error checking and system interaction. Starting at 502, for each token 504, it is determined at 506 if the token is declared extrinsic. If the token is extrinsic 508 then at 512 an element structure is created in the semantic manifold where the symbol is the token and the cardinal is extrinsic. If the token is determined not to be defined as extrinsic 510 at 506, then the domain specific language definition of the worker is searched for a prescription with a symbol or alias matching the token. At 524 it is determined if a prescription was found at 522. If no prescription was found 526, the token is extrinsic and is handled accordingly at 512. If no prescription was found 528 at 524, then the token is intrinsic and an element structure is created in the semantic manifold where the symbol is the token and cardinals are all cardinals in the prescription. From both 512 and 530, it is determined at 514 if the current token is the last token. If the current token is the last token 518, then the system returns at 532. If the current token is not the last token 516, the next token is selected at 520 and operation for the next token resumes at 506.

FIG. 6 is a flow chart of the process to check sentence grammar for the particular embodiment including enhanced error checking and system interaction. Starting at 602 for each element in the semantic manifold 604 the cardinals for the element are retrieved at 606. If multiple cardinals are not found 610 at 608, then the element is an extrinsic element and operation checks to see if the current element is the last element at 640. If multiple cardinals are found 612 at 608, then, for each cardinal in the element 614, each cardinal is checked to see if the cardinal has a grammar check function at 618. If there is a grammar check function 620 for the cardinal, the grammar check function is run at 622 and the current cardinal is checked to determine if the current cardinal is the last cardinal at 626. If there is not a grammar check function 624 for the cardinal at 618, then operation continues 626 to check to determine if the current cardinal is the last cardinal. If the current cardinal is not the last cardinal 628 at 626, then the next cardinal is selected at 650 and operation continues at 618. If the current cardinal is the last cardinal 630 at 626, the system checks the element to see if it still reports multiple cardinals at 632. If there are still multiple cardinals 636 at 632, then the system returns with an error at 638. If there are not multiple cardinals 634 at 632, then operation continues at 640 to check to see if the current element is the last element. If the current element is the last element 642 at 640, then the system returns completed at 648. If the current element is not the last element 644 at 640, then the next element is selected at 646 and operation continues at 606.

FIG. 7 is a flow chart of the process to parse the semantic manifold to create the job queue for the particular embodiment including enhanced error checking and system interaction. Starting at 702, the order of operation is retrieved from the domain specific language at 704. For each operation in the order of operation 706, the operation is tokenized at 708. For each element in the semantic manifold 710, “E” is defined as the position of the element in the semantic manifold at 712. For each token in the operation 714, “T” is defined as the position of the token in the operation at 716. At 718 the cardinal of the element at position E+T is compared to the operation token at 718 and if a match is found 724 at 720, the prescription of the element at E+T is appended to the current prescription at 726. If a match is not found 722 at 720, operation continues at 766 to check to see if the current element is the last element in the semantic manifold. From 726, operation continues at 728 to check if the current operation token is the last token. If the current operation token is not the last token 730 at 728, then the next operation token is selected at 732 and operation returns to 716. If the current operation token is the last token 734, then the domain specific language is searched for a command matching the prescription and operation at 736. If a command is found 740 at 738, then the prescription is added to the command list at 742 and operation continues to search for a default job attribute of the selected element at 746. If the command is not found 744 at 738, then the selected element is searched for a default job attribute at 746. If a default job for the selected element is found 752 at 748, then the default job is added to the job queue at 754 and operation continues to 766. If a default job for the selected element is not found 750 at 748, then the domain specific language is searched for jobs matching the prescription and operation at 756. If a job is not found 760 at 758, then operation continues at 766. If a job is found 762 at 758, then the job is added to the job queue at 764 and operation continues at 766. At 766, it is determined if the current element is the last element in the semantic manifold. If the current element is not the last element 768 at 766, then the next element is selected at 772 and operation continues at 712. If the current element is the last element 770 at 766, then it is checked if the current operation is the last operation at 774. If the current operation is not the last operation 776 at 774, then the next operation is selected at 778 and operation continues at 708. If the current operation is the last operation 780 at 774, then it is checked to see if multiple commands were found at 782. If multiple commands were found 788 at 782, then an ambiguous input error is returned at 790. If multiple commands were not found 784, then a complete is returned at 786.

FIG. 8 is a flow chart of the process to execute jobs and create the command translation for the particular embodiment including enhanced error checking and system interaction. Starting at 802, for each job in the job queue 804, the job is split into function and arguments at 806. If the function does not exist 810 at 808, then an error is returned at 812. If the function does exist 814 at 808, then the function is called with the arguments at 816. If the function call returned an error 820 at 818, then the function returned error is returned at 822. If function call did not return an error 824 at 818, then the semantic manifold is checked for changes to elements caused by the function call at 826. If the semantic manifold changed 830 at 828, then an incomplete is returned at 832. If the semantic manifold did not change 834 at 828 then it is checked to see if the current job is the last job in the job queue at 836. If the current job is the last job 838 at 836, then a complete is returned at 840. If the current job is not the last job 842 at 836, then the next job in the job queue is selected at 844 and operation returns to 806.

FIG. 9 is a flow chart of the process to validate a command translation for the particular embodiment including enhanced error checking and system interaction. Starting at 901, the semantic manifold is searched for elements with values and the values are concatenated at 902. If values are not found 904 at 903, then an error is returned at 905. If a value is found 906 at 903, then the values are searched for required markers at 907. If markers are found 910 at 908 then operation continues at 947 (note that the branch of operation for 947 will be described after the description of operation for not finding markers 909 at 908). If markers are not found 909 at 908 then the values are search for optional markers at 911. If optional markers are not found 913 at 912 then a complete is returned at 914. If optional markers are found 915 at 912, then for each optional marker in the list of optional markers 916, the domain specific language for the prescription utilizing the current marker is searched at 917. If the prescription is not found 919 at 918 then an error is returned at 920. If the prescription is found 921 at 918, then the found prescription is selected as the current prescription at 922 and the semantic manifold is searched for elements utilizing the current prescription at 923. If elements are not found 925 at 924, then new elements are created for the semantic manifold with symbols, prescriptions and cardinals derived from the current prescription at 926. The new elements from 926 are appended to the end of the semantic manifold at 927 and an incomplete is returned at 928. If new elements are found 929 at 924, then the current elements are designated as the elements found at 930. At 931 the cardinals of the elements found are concatenated to form a current cardinal. At 932, the domain specific language is searched for a question associated with the current prescription and current cardinal. If the question is found 934 at 933, then the question cache is searched for an entry matching the current prescription and current cardinal at 935. If an entry for the question is not found 937 at 936, then an entry in the question cache is created for the current prescription and current cardinal at 938 and a question is returned at 939. If an entry for the question is found 940 at 936, then it is checked to see if the current optional marker is the last optional marker at 941. If the current optional marker is the last optional marker 942 at 941, then a complete is returned at 943. If the current optional marker is not the last optional marker 944, then the next optional marker is selected at 945 and operation continues at 917. If the question is not found 946 at 933, then the next optional marker is selected at 945 and operation continues at 917.

If a required marker was found for the values 910 at 908, then for the required markers in the list of required markers 947 the domain specific language is searched for the prescription utilizing the current marker at 948. If the prescription is not found 950 at 949, then an error is returned at 951. If a prescription is found 952 at 949, then the prescription found is designated the current prescription at 953. At 954 the semantic manifold is searched for elements utilizing the current prescription. If elements are not found 956 at 955, then new elements are created for the semantic manifold with symbols, prescriptions and cardinals derived from the current prescription at 957, the new elements are added to the semantic manifold at 958 and an incomplete is returned at 959. If elements are found 960 at 955, then the current element is designated the element found at 961. At 962, the cardinals of the element found are concatenated to form the current cardinal. At 963, the domain specific language is searched for the default value associated with the current prescription and current cardinal. If a default value is found 965 at 964, then new elements are created for the semantic manifold with the token as the symbol and the cardinal is extrinsic at 966, the new elements are added to the semantic manifold at 967 and an incomplete is returned at 968. If a default value is not found 969, then the domain specific language is searched for a default job associated with the current prescription and current cardinal at 970. If a default job is found 972 at 971, then the default job is inserted into the current elements of the semantic manifold at 973 and an incomplete is returned at 974. If a default job is not found 975 at 971, then the domain specific language is searched for a question associated with the current prescription and current cardinal at 976. If a question is not found 978 at 977, then an error is returned at 979. If a question is found 980 at 977, then the question cache is searched for an entry matching the current prescription and current cardinal at 981. If a question entry is not found in the question cache 983 at 982, then an error is returned at 984. If a question entry is found in the question cache 985 at 982m then an entry is created in the question cache with the current prescription and current cardinal at 986 and a question is returned at 987.

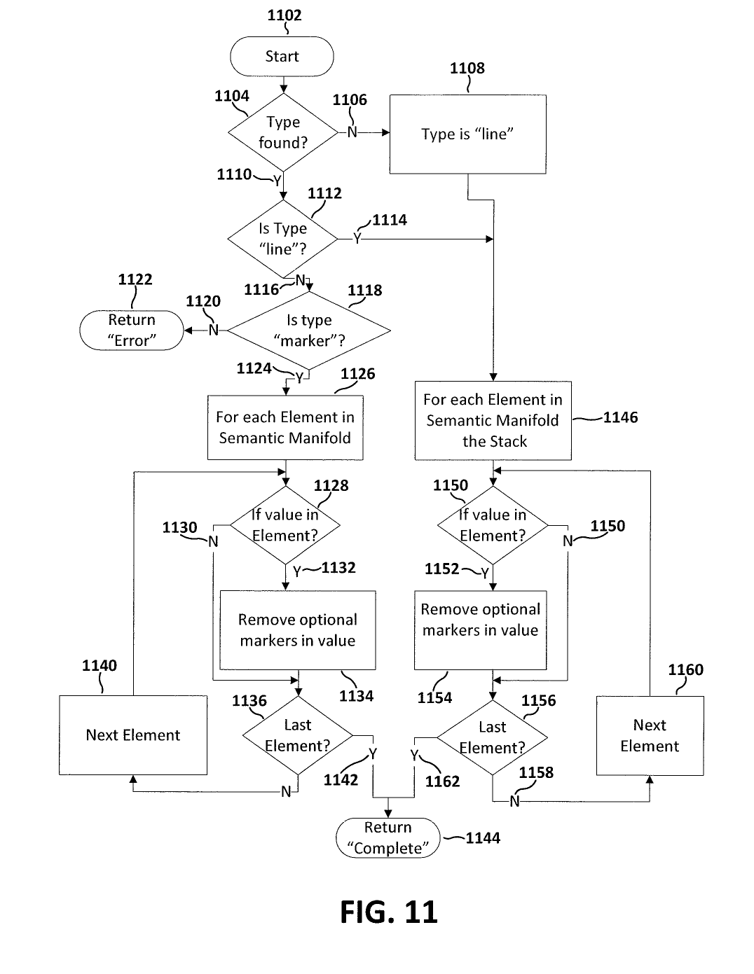

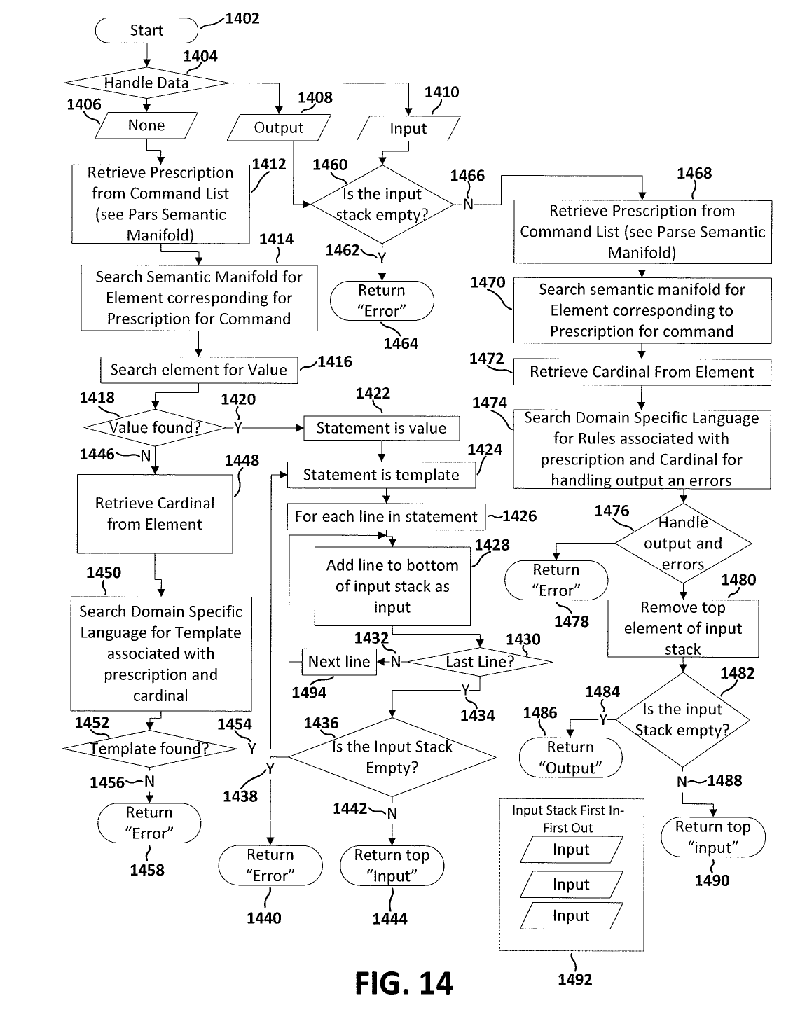

FIG. 10 is a flow chart of the process for processing the command translation for the particular embodiment including enhanced error checking and system interaction. Starting at 1002, if data is found 1006 at 1004, then function input is called with data as the argument at 1008. The function input is discussed in more detail in the disclosure with respect to FIG. 14. If data is not found 1010 at 1004, the prescription is retrieved from the from the command list at 1012. At 1014 the semantic manifold is searched for elements corresponding to the prescription for the command. At 1016, the cardinals are retrieved from the elements. At 1018 the cardinals are concatenated to create a current cardinal. At 1020, the domain specific language is searched for command functions associated with the current prescription and current cardinal. If functions are not found 1024 at 1022, then an error is returned at 1026. If functions are found 1028 at 1022, then, for each function in the command functions 1030 it is determined if the function exists at 1032. If the function does not exist 1034 at 1032, then an error is returned at 1036. If the function does exist 1038 at 1032, then the function is called at 1040. FIGS. 11-14 represent potential functions called at 1040. The return handler 1042 handles the return value from the called function of 1040. If the return handler results in an error 1044, output 1046, or input 1048, the return handler 1042 result is returned at 1052. If the return handler 1042 result is complete 1050, then it is determined if the current function is the last function at 1054. If the current function is the last function 1060 at 1054, then no function returned an error, output or input 1062 and an error is returned at 1064. If the current function is not the last function 1056, then the next function is selected at 1058 and operation continues at 1032.

FIG. 11 is a flow chart of the process for the clean process translation function for the particular embodiment including enhanced error checking and system interaction. Starting at 1102, it is determined if a type is found at 1104. If a type is not found 1106 at 1104, then the type is set to “line” at 1108 and operation continues at 1146. If a type is found 1110 at 1104 then it is determined if the type is “line” at 1112. If the type is line 1114 at 1114, then operation continues at 1146. If the type is not “line” 1116 at 1112, then it is determined if the type is “marker” at 1118. If the type is not “marker” 1120 at 1118, then an error is returned at 1122. If the type is “marker” 1124 at 1118, then, for each element in the semantic manifold 1126, it is determined if the value is in the element at 1128. If the value is not in the element 1130, then it is determined if the current element is the last element at 1136. If the value is in the element 1132 at 1128, then optional markers are removed at 1134 and it is determined if the current element is the last element at 1136. If the current element is the last element 1142 at 1136, then a complete is returned at 1144. If the current element is not the last element 1138 at 1136, then the next element is selected at 1140 and operation continues at 1128. For “line” types for each element in the semantic manifold 1146, it is determined if the value is in the element at 1148. If the value is not in the element 1150, then it is determined if the current element is the last element at 1156. If the value is in the element 1152 at 1148, then optional markers are removed at 1154 and it is determined if the current element is the last element at 1156. If the current element is the last element 1162 at 1156, then a complete is returned at 1144. If the current element is not the last element 1158 at 1156, then the next element is selected at 1160 and operation continues at 1148.

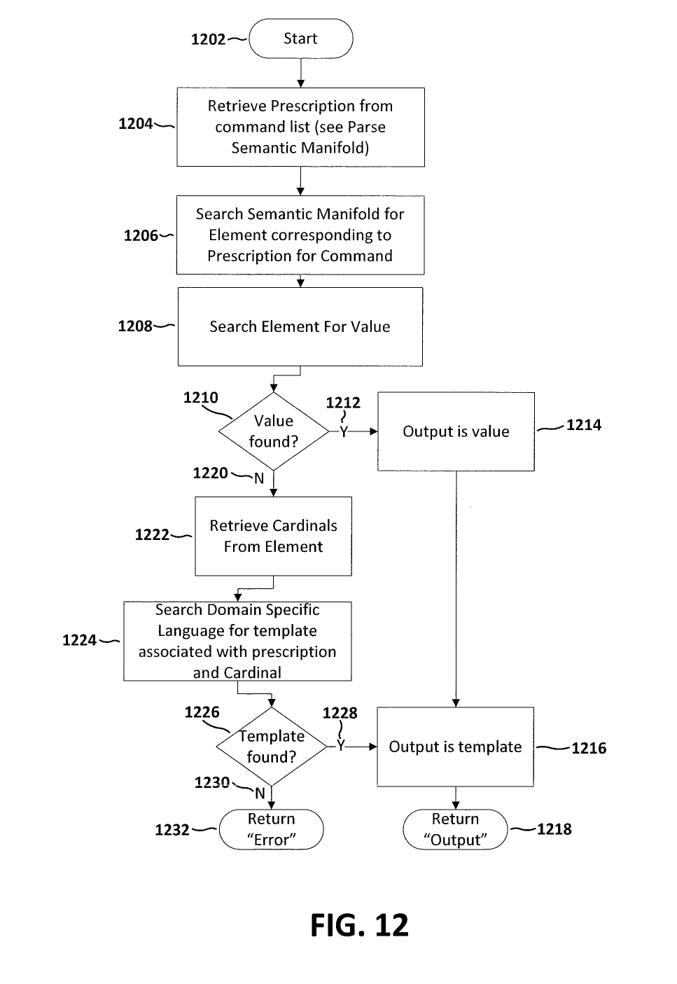

FIG. 12 is a flow chart of the process for the display process translation function for the particular embodiment including enhanced error checking and system interaction. Starting at 1202, a prescription is retrieved from the command list at 1204. At 1206, the semantic manifold is searched for an element corresponding to the prescription of the command. At 1208, the element is searched for a value. If a value is found 1212 at 1210, then the output is set to the value at 1214 and the output is the template at 1216 and the output is returned at 1218. If a value is not found 1220 at 1210, then cardinal is retrieved from the element at 1222. At 1224, the domain specific language is searched for a template associated with the prescription and cardinal. If a template is found 1228 at 1226, then the output is set to the template at 1216 and the output is returned at 1218. If a template is not found 1230 at 1226, then an error is returned at 1232.

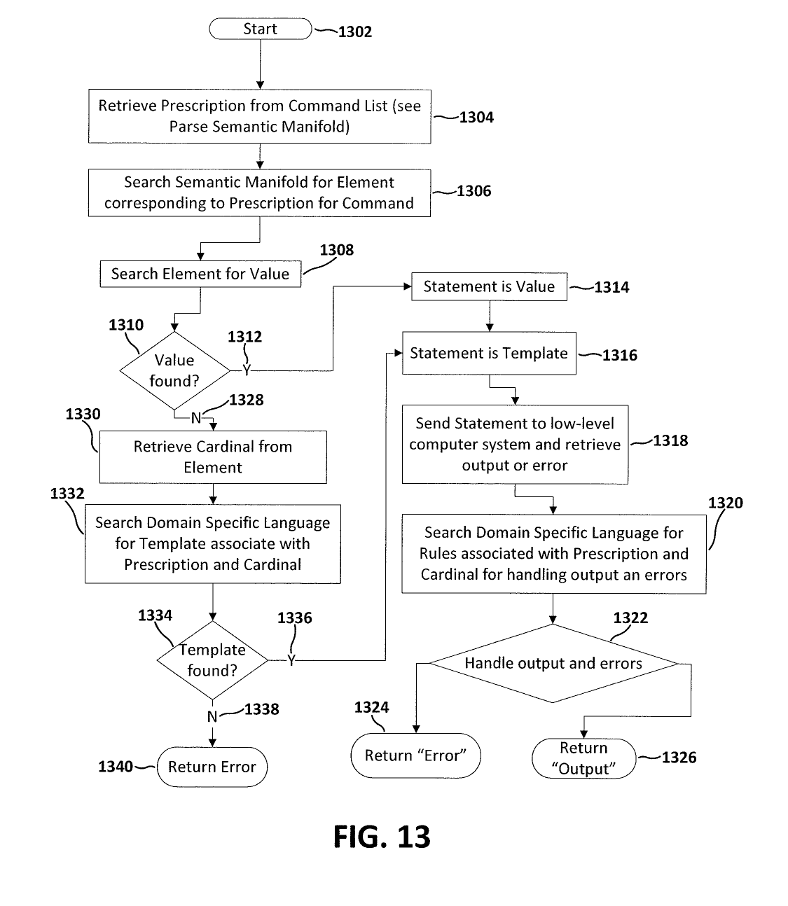

FIG. 13 is a flow chart of the process for the subprocess process translation function for the particular embodiment including enhanced error checking and system interaction. Starting at 1302, a prescription is retrieved from the command list at 1304. At 1306, the semantic manifold is searched for an element corresponding to the prescription of the command. At 1308, the element is searched for a value. If a value is found 1312 at 1310, then the value is set to the statement at 1314 with operation continuing thereafter at 1316. If a value is not found 1328 at 1310, then cardinal of the element is retrieved at 1330. At 1332, the domain specific language is searched for a template associated with the prescription and cardinal. If a template is not found 1338 at 1334, then an error is returned at 1340. If a template is found 1336 at 1334, then operation continues at 1316. At 1316, the statement is set to the template. At 1318, the statement is sent to a low level computer system and an output or error is returned. At 1320, the domain specific language is searched for rules associated with prescription and cardinal for handling output and errors. The output and error handler 1322 returns an error at 1324 for errors and an output 1326 for outputs.

FIG. 14 is a flow chart of the process for the input process translation function for the particular embodiment including enhanced error checking and system interaction. Starting at 1402, data handler 1404 selects between none 1406, output 1408, or input 1410. If data handler 1404 selects none 1406, then a prescription is retrieved from the command list at 1412. At 1414, the semantic manifold is searched for the element corresponding to the prescription for the command. At 1416, the element is searched for a value. If a value is found 1420 at 1418, the statement is set to the value at 1422 and operation continues at 1424. If the value is not found 1446 at 1418, then the cardinal is retrieved from the element at 1448. At 1450, the domain specific language is search for at template associated with the prescription and cardinal. If a template is not found 1456 at 1452, then an error is returned at 1458. If a template is found 1454 at 1452, then the statement is set to the template at 1424. For each line in the statement 1426 at line is added to the bottom of the input stack 1492 as an input at 1428. If the current line of the statement is not the last line of the statement 1432 at 1430, then the next line of the statement is selected at 1494 and operation continues at 1428. If the current line of the statement is the last line of the statement 1434, then it is determined if the input stack 1492 is empty at 1436. If the input stack 1492 is empty 1438, an error is returned at 1440. If the input stack 1492 is not empty 1442, then the top input is returned at 1444. If data handler 1404 results in output 1408 or input 1410, then it is determined if the input stack 1492 is empty at 1460. If the input stack 1492 is empty 1462 at 1460, then an error is returned at 1464. If the input stack 1492 is not empty 1466 at 1460, then a prescription is retrieved from the command list at 1468. At 1470, the semantic manifold is searched for an element corresponding to the prescription from the command list. At 1472, the cardinal is retrieved from the element. At 1474, the domain specific language is searched for rules associated with the prescription and cardinal that handle output and errors. The output and error handler 1476 returns an error 1478 for errors and moves to 1480 for outputs. At 1480, the top element is removed from the input stack 1492. If the input stack 1492 is empty 1484 at 1482, output is returned at 1486. If the input stack 1492 is not empty 1488 at 1482, then a input is returned at 1490.

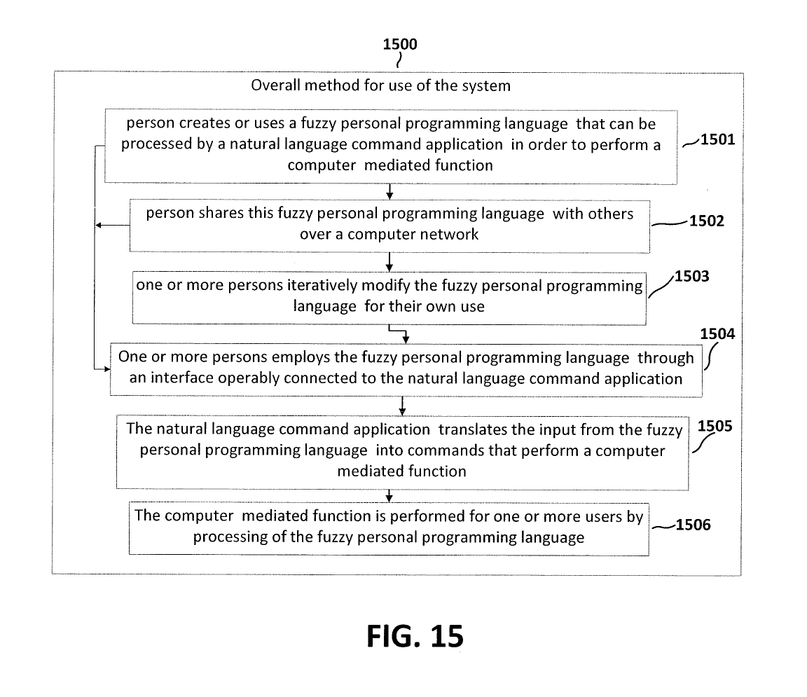

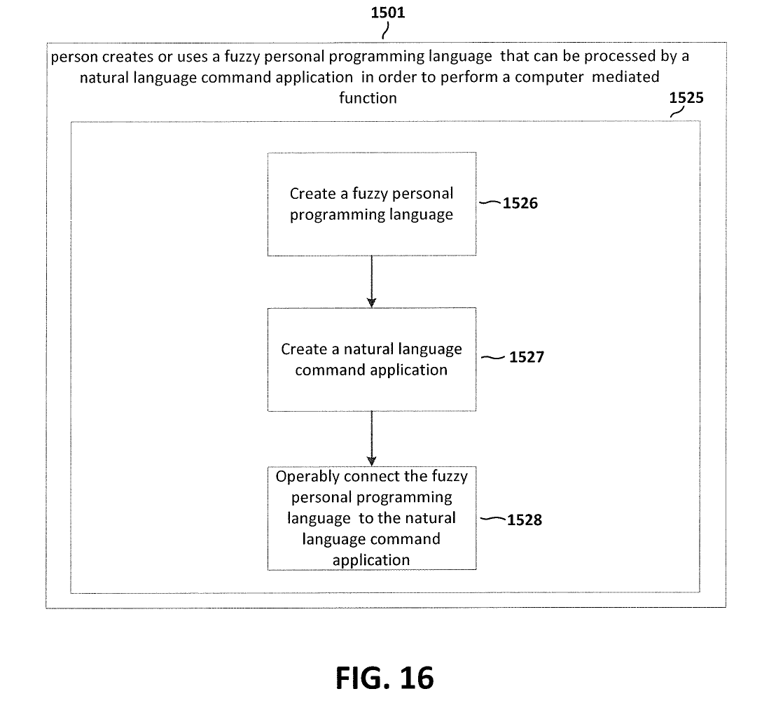

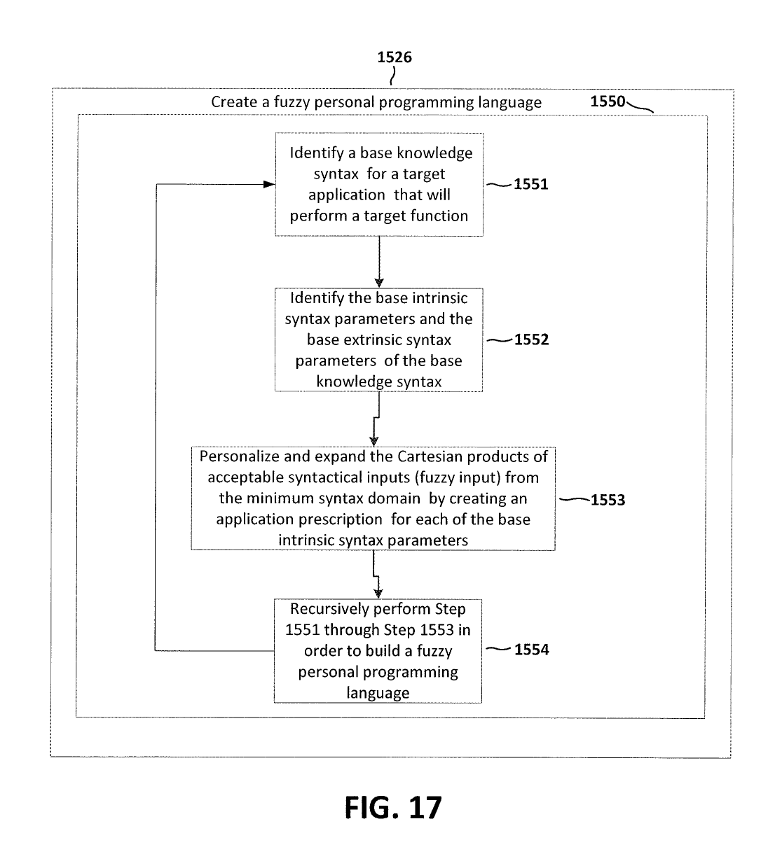

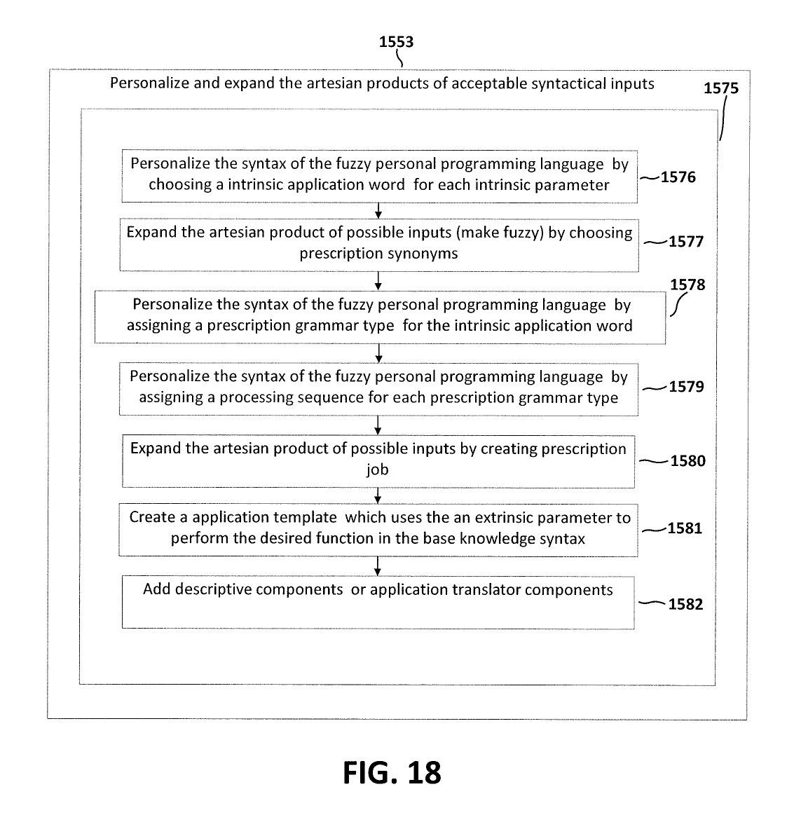

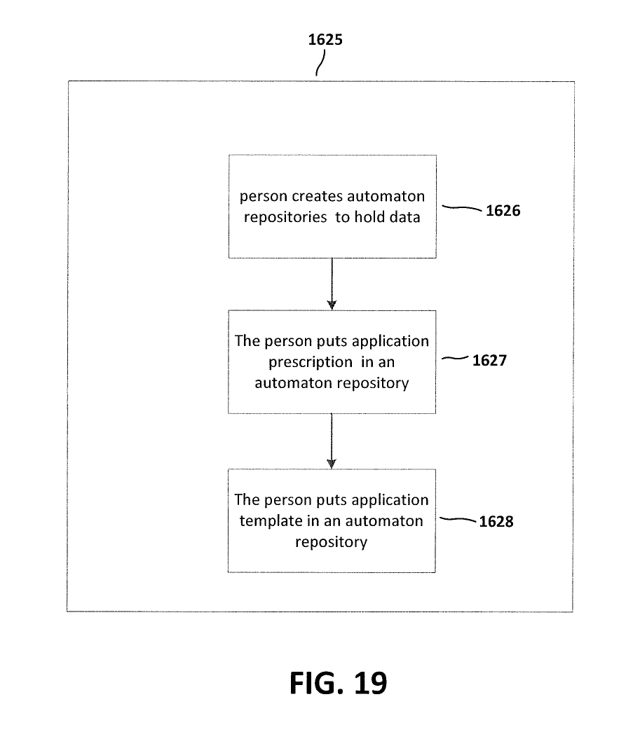

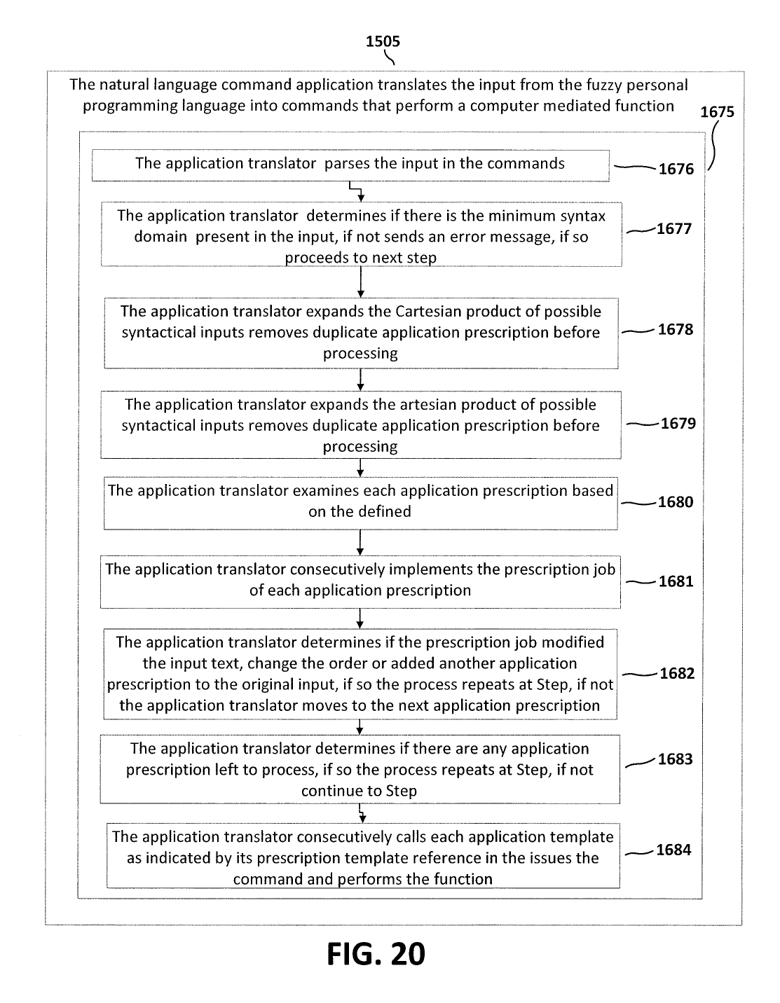

FIG. 15 is a diagrammed series of steps view that shows the overall use of a particular embodiment. FIG. 16 is a diagrammed series of steps view that shows the creation of the functional parts of the system of the particular embodiment. FIG. 17 is a diagrammed series of steps view that shows creation of the fuzzy personal programming language of the particular embodiment. FIG. 18 is a diagrammed series of steps view that shows the creation of the prescription of the particular embodiment. FIG. 19 is a diagrammed series of steps view that shows the creation of the prescription storage components of the particular embodiment. FIG. 20 is a diagrammed series of steps view that shows the natural language command application processing of a fuzzy input created by the system in order to perform a function of the particular embodiment. The particular embodiment described by FIGS. 15-20 has several sub steps for using the particular embodiment described in more detail below. The disclosure of FIGS. 15-20 are taken together as a whole as steps on one figure may be disclosed in further detail in sub steps on another figure.

In general for the particular embodiment of FIGS. 15-20, an expert user may create or use a fuzzy personal programming language that can be processed by a natural language command application in order to perform a computer mediated function 1501. The term fuzzy personal programming language may be defined as a programming language wherein the syntax is personalized to terms relevant to the user and can accept many possible variations of input in order to perform the same specific function.

Step 1501 has several sub steps. To start, one would create the fuzzy personal programming language itself at step 1526, which may itself comprise several more sub steps. To start, one would first identify a base knowledge syntax for a target application that will perform a target function at step 1551. The base knowledge syntax may be commands or symbols employed by a target application that may be necessary in order to perform a function. The function may be comprised of two parts, base intrinsic syntax parameters and base extrinsic syntax parameters. The target application may be an application that performs a desired target function that is operated by the natural language command application. The target application may be a computer program, where the target function may be broadly thought to include beneficial or desired computer-mediated action for the user, such as create a server or create an email setup.

Next one might identify the base intrinsic syntax parameters and the base extrinsic syntax parameters of the base knowledge syntax, which make up the minimum syntax domain that are necessary in order for the target application to perform the function at step 1552. Step 1552 is intended to separate the functional syntax from the data operated on by the syntax. For Step 1552, the base intrinsic syntax parameters may be representations of function names, representations of class names, representations of command line commands, or recursive representations of application prescriptions, where the base extrinsic syntax parameters may be arguments of a function, properties of a class, or fields of a database table. Further, the minimum syntax domain may be defined as an array of entities that correspond to the minimum amount of distinct information points that are necessary to perform a desired function. The establishment of the minimum syntax domain aims to both 1) have an easy feedback mechanism check point for whether or not a function may be performed from a command by deterring whether or not a list of functions has the required parameters, and also to 2) have an intuitive mechanism by which a user may implement a function without a sequence-dependent decision tree.

Next, one may personalize and expand the Cartesian products of acceptable syntactical inputs (fuzzy input) from the minimum syntax domain by creating an application prescription for each of the base intrinsic syntax parameters, and then choosing a processing sequence at step 1553, which itself is composed of multiple sub steps. In order to accomplish step 1553, one first personalizes the syntax of the fuzzy personal programming language by choosing an intrinsic application word for each base intrinsic syntax parameter that reflects the natural language one uses to manage the target application at step 1576. This may be done in order to choose the series of words or symbols that are comfortable for the user to use to command a function to perform. The term intrinsic application word may be broadly thought to include a word associated with an application prescription where the intrinsic application word may be defined by its association to the prescription and where the prescription may reflect the putative function in the mind of the user. The intrinsic application word may be a reserved word, command word, command option, a word that reflects the function of a base syntax parameter or a word that reflects the function of a base syntax parameter in the language of the user.

Next, one might expand the Cartesian product of possible inputs (make fuzzy) by choosing prescription synonyms for each intrinsic application word that is a likely alternative that may be chosen by the user at step 1577. The use of the prescription synonym may create an array of substitute intrinsic application words that the user may type or suggest when interfacing with the particular embodiment.

Next one might personalize the syntax of the fuzzy personal programming language by assigning a prescription grammar type for the intrinsic application word reflecting the grammar function of the word in the natural language of the user at step 1578. The prescription grammar type may function to identify an intrinsic application word as a feature of the grammar of the natural language of the user. For example, the prescription grammar type may 1) identify a type of symbol which corresponds to a verb in natural language, or 2) identify a type of symbol used in a human input which corresponds to the indirect object of a natural language. In documents incorporated by reference, the instances of a prescription grammar type may be referred to as actions, identifiers, action identifiers, and parameters.

Next one might personalize the syntax of the fuzzy personal programming language by assigning a processing sequence for each prescription grammar type indicating the word order comprehension as understood in the natural language of the user at step 1579. Step 579 may create a non-sequential order of input processing that reflects the natural language of the user. Both step 1578 and 1579 increase the Cartesian product of possible syntactical inputs as well.

Next one might again expand the Cartesian product of possible inputs by creating a prescription job that programmatically alters the text, order or values of itself and any other application prescription at step 1580. This may be an optional function associated with an application prescription that modifies input that may come from user input or another prescription job associated with another application prescription. Step 1580 may 1) create a means to address the possible variability in comprehension states of the familiarity of the user with the base knowledge syntax and the intrinsic application word of the application prescription, or 2) create a means to connect recursive application prescriptions to each other.

A prescription job may be 1) a job that modifies the input so that the job inserts a prefix before specified intrinsic application words in the input, 2) a job that modifies the input by breaking it up with a delimiter and assigning the resultant strings to different portions of the input text as an intrinsic or extrinsic parameter, 3) a job used to replace all template placeholders with base extrinsic syntax parameters, 4) a job that declares how many basic extrinsic syntax parameters may be assigned to an intrinsic application word, or 5) a job that determines how many times the intrinsic application word will be accepted input.

Next, one might create an application template which uses the base extrinsic syntax parameter in order to perform the desired function of the base knowledge syntax at step 1581. The application template may be a reusable processor target application template text that may include a template placeholder within partial segments of operational code or pertinent configurations. The target application template text may be broadly thought to include the partial text of the target application commands and template placeholders that may be used to perform a function in the target application. The template placeholder may allow variable descriptive instructions to be processed. The last part of FIG. 18 discloses adding descriptive components or application translator components to the application prescription at step 1582. Descriptive components help to organize and manage the prescription as metadata. The descriptive components may be 1) a prescription label, defined as an optional feature which provides a human readable name or title for the prescription, 2) a prescription description, defined as a prescription element which provides a means for a human readable synopsis of the prescription, or 3) a prescription abbreviation, defined as a shorthand version of the intrinsic application word.

Application translator components may be general utility programming means that are necessary in order for the translator components to work with the application translator. Example components may be 1) a prescription cardinal, defined as: a prescription element that states a symbol type, purpose, and usage in grammar, which is also used to establish the processing sequence, 2) a prescription key, defined as a an element that links an intrinsic application word to the application prescription, or 3) a prescription template reference: defined as a prescription element that stores a reference to a application template.

After a minimum syntax has been defined for a function and each of the prescriptions have been created, one may then iteratively perform step 1551 through step 1553 in order to build a fuzzy personal programming language with different functions while still re-using similar syntax 1554 of the overall series of steps of 1550.

To use the fuzzy personal programming language, one might next create a natural language command application at step 1527. The natural language command application may have 3 components, respectively defined as the command application interface, the application translator, and the application automaton. The command application interface may be provide a means for inputting commands that closely resemble natural language to control the target application. For example, a graphical user interface or microphone may provide the necessary functionality. However, one skilled in the art may deem that if the command application interface is absent in some embodiments, then it is possible that there may be computer to computer communication, and, thus, a human interface would not be necessary. The term application translator may be broadly thought to include a device that 1) has means to accept human input, 2) looks for the associated application prescription, 3) finds the minimum syntax domain, 4) implements the prescription jobs, and 5) generates computer code using application prescription and template file. In other words, the application translator may process the application prescriptions. The application automaton may be the composite codebase that includes the automaton repositories, which may be a means for storing application templates or application prescriptions such as, for example, a prescription file, a template file, or a database.

After creating the natural language command application, one might operably connect the fuzzy personal programming language to the natural language command application at step 1528. Step 1528 may also have several sub steps: First, one may create the automaton repositories in order to hold data at step 1626. Next, one might put one or more application prescriptions in to an automaton repository at step 1627. Then, one might put one or more application templates in the automaton repository, at step 1628. The prescriptions in the repositories may then be searchable by the natural language command application, thus, operably connecting the natural language command application to the fuzzy personal programming language as part of the overall series of steps of 1625.

After creating or using the fuzzy personal programming language that may be processed by the natural language command application, a user may then share the fuzzy personal programming language with other users over a computer network at step 1502. However, it is reasonable to contemplate that if step 1502 is not included in some alternative embodiments, then the user may use the fuzzy personal programming language for personal use. At step 1503, it is also contemplated that one or more users may iteratively modify the fuzzy personal programming language for their own use or use by others, by returning to step 1501 to create additional fuzzy language. However, in some other embodiments, it is also thought that if step 1503 is excluded, then a user may utilize the fuzzy personal programming language of another person, or alternatively, that the user may use the fuzzy personal programming language for personal use.

Next, one or more users may employ the fuzzy personal programming language through an interface operably connected to the natural language command application at step 1504. After step 1504, the natural language command application may translate the input from the fuzzy personal programming language into commands that perform a computer mediated function at step 1505.

Step 1505 also has several sub steps. The application translator parses the input in the commands at step 1676. Next, the application translator determines if there is the minimum syntax domain present in the input at step 1677, and, if not, sends an error message or if the minimum syntax domain is present, then proceed forward. Next, the application translator expands the Cartesian product of possible syntactical inputs and removes duplicate application prescriptions before performing additional processing at step 1678. Then, the application translator expands the Cartesian product of possible syntactical inputs and removes duplicate application prescription before performing further processing at step 1679. Then, the application translator may examine each application prescription based on the defined input at step 1680. Then, the application translator may consecutively implement the prescription job of each application prescription at step 1681. Then, for step 1682 the application translator may determine if the prescription job modified the input text, changed the order or added another application prescription to the original input and, if so, the process repeats at from step 678, if not the application translator moves to the next application prescription. Then, for step 1683 the application translator may determine if there are any application prescriptions left to process and, if so, the process repeats from step 1678, if not, the process continues to step 1684. At step 1684, the application translator consecutively calls each application template as indicated by its prescription template reference and issues the command and performs the function. The overall series of steps is identified as 1675.

At step 1506, the computer mediated function may be performed for one or more users. The overall series of steps from 1501 to 1505 is identified as 1500 and is the general overall method of using the particular embodiment disclosed by FIGS. 15-20.

The following identification of terms is provided to assist the reader in understanding the meaning of the terms used to describe the various embodiments. The term memory may be broadly thought to include the physical devices used to store programs (sequences of instructions) or data (e.g., program state information) on a temporary or permanent basis for use in a computer or other digital electronic device. The term operating system may include a collection of software that manages computer hardware resources and provides common services for computer programs. The term graphical user interface may include a type of user interface that allows users to interact with electronic devices through graphical icons and visual indicators such as secondary notation, as opposed to text-based interfaces, typed command labels or text navigation. The term programming may be thought to encompass the comprehensive process that leads from an original formulation of a computing problem to executable programs. The term database may be used to describe an organized collection of data with a software system interface designed to allow the definition, creation, querying, update, and administration of information in the database. The term computer network may be used to describe any type of communication connection between two computing devices. The term program may be understood to include a sequence of instructions, written to perform a specified task with a computer that is executed by the central processing unit. The term software may be used to describe a collection of computer programs and related data. The term programming language may be used to describe an artificial language designed to communicate instructions to a machine, particularly a computer. The term minimum syntax domain may be used to describe an array of entities that correspond to the minimum amount of distinct information points that are necessary to perform a desired function. The term base knowledge syntax may be used to describe the commands or symbols employed by a target application to perform a function. The term base extrinsic syntax parameters may be used to describe variable inputs from the command application interface that application translator may use as a specific instruction for a target application. The term application template may be used to describe a reusable processor instruction text that may include: template placeholders, partial segments of operational code, or pertinent configurations. An application template may be comprised of one or more similar (recursive) application templates or other application templates. The term template placeholder may be used to describe a means for a configuration space that is part of an application template that is used to have variable descriptive instructions for application automaton processing. The term target application template text may be used to describe the partial text of the target application commands and template placeholder 43 that may be used to perform a function in the target application. The term prescription cardinal may include a symbol type, purpose, and usage in grammar. The term prescription key may be used to describe an entity that equates an intrinsic application word with an application prescription. The term prescription template reference may be used to describe a location that stores a reference to an application template. The term application prescription may be used to describe a means for providing the application translator instructions to perform when words and phrases are encountered from input into the natural language command application. The term natural language command application may be used to describe a means for controlling a target application through commands that closely resemble natural language and that may be software or a program. The term command application interface may be use to describe a means for inputting commands that closely resemble natural language to control a target application. The term application translator may be used to describe a means to accept human input, look for the associated application prescription and, in order to find the minimum syntax domain, implement the prescription jobs based on the computer code generated using application prescription and template files. The term application automaton may be used to describe the composite codebase that includes the automaton repositories. The term automaton repositories may be used to describe a means for storing application templates or application prescription. The term prescription file may be used to describe a text file containing a list of application prescriptions. The term template file may be used to describe a text file containing partial target application instructions and/or configuration entries. The term fuzzy personal programming language may be used to describe a programming language where the syntax of the programming language is personalized to terms relevant to the user and may accept many possible variations of input in order to perform a specific function. The term semi formal grammar may be used to describe the acceptable structure of input into the command application interface and a means for intuitive recognizance of human input for controlling a target application.

Various embodiments may provide a system and/or method that allows a user to rapidly create their own programming commands in words that mean something to the user. Further, various embodiments may allow users to do rapidly create fuzzy input syntax so that the precise word order or words are not necessary in order to perform a specific function. Further, for various embodiments, the commands may be used recursively allowing the building of a personalized fuzzy input programming language, which may then be used for personal use, shared with others or mixed and matched in a modular way.

The fuzzy input generation may be a result of the ability of an embodiment to increase the syntax “net” (i.e., the Cartesian product of input possibilities by making objects called prescriptions). Prescriptions may be modular objects linked to both a command function (or another prescription) and also to a specific word(s). In general, the various embodiments may both personalize and increase the syntax net of input in five ways. 1) colloquial words allowed within the syntax input, 2) synonyms for verbs or parts of the syntax grammar are self-defined, 3) the grammarial order of operations for processing the command may be self defined based on the desired dialect of the user, 4) a variable knowledge state of “proper syntax” of the user may be accounted for by unpacking/recursive use of prescription jobs, which may reset and alter the command input, and/or 5) recursive use of prescriptions allows building of one's “own” programming language. Each individual mechanism of the various embodiments may provide a way to vastly increase the acceptable syntax of a target audience for performing a specific function. Furthermore, each mechanism of the various embodiments may allow specific tweaking based on the target application.

The various embodiments may allow people to collaborate on an important part of functional programming including the decision on the syntax to perform functions; allow non programmers to create their own programming languages; allow different users to use different syntax for the same functions; allow users to recursively build their own self-defined programming language by reusing the same syntax words for new functions; allow users from different countries to assert their own syntax to specific computer functions; allow users to create variable input syntaxes such that many different inputs may achieve the same function and such that it resembles intuition or learning from the computer; allow users to create arbitrary levels of syntax variability dependent on the familiarity of their knowledge with the system that is being operated; allow users to use colloquial words and text to input data as part of the operating syntax, allow users to trade prescriptions and syntax descriptions in order to collaboratively build familiar programming languages for a group, without having to understand traditional language syntactic elements such as function declaration, variables, arguments, if-then statements, or arrays; allow users to operate a machine using their own terms; allow users to vastly increase the acceptable syntactic input to perform a function in a modular manner; and, allow users to vastly increase the acceptable syntactic input without defining sequential decision trees.

Various embodiments may provide the control and management functions detailed herein via an application operating on a computer system (or other electronic devices). Embodiments may be provided as a computer program product which may include a computer-readable, or machine-readable, medium having stored thereon instructions which may be used to program/operate a computer (or other electronic devices) or computer system to perform a process or processes in accordance with the present invention. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A computerized method for controlling at least one target application running on a computer system based upon a natural language command string from a user, said computerized method comprising:
receiving at said computer system said natural language command string from said user;
parsing by said computer system said natural language command string to create a list of tokens contained in said natural language command string, each token of said list of tokens being a word or defined phrase in said natural language command string;
determining by said computer system a symbol and cardinals for each token in said list of tokens as a function of an analysis of a domain specific language definition stored on said computer system, said symbol being representative of said token and said cardinals being parameters that describe a usage and an order-of-operation for each token;
creating by said computer system in a semantic manifold an element for each token in said list of tokens such that said semantic manifold contains a list of elements corresponding to said list of tokens, said element being a data structure that stores said symbol and said cardinals of a token,
creating by said computer system a queue of jobs based on elements in said semantic manifold as a function of an order-of-operation and element prescriptions in said domain specific language definition and said cardinals of each element in said list of elements of said semantic manifold, a job being at least one procedure defined in said domain specific language definition declaring operations to create a translation of an element into code and/or configurations that controls said at least one target application;
selecting by said computer system a first job in said queue of jobs as a selected job based on said order-of-operations and element prescriptions in said domain specific language definition;
executing by said computer system said selected job in order to create a command translation built from execution of each job in said queue of jobs;
determining by said computer system if said list of elements in said semantic manifold has changed;
when said list of elements in said semantic manifold is determined to be changed, returning operation by said computer system to said step of creating said queue of jobs based on said list of elements as said function of said order-of-operation and element prescriptions in said domain specific language definition and said cardinals of each element in said list of elements of said semantic manifold;
when said list of elements in said semantic manifold is determined not to be changed, determining by said computer system if said selected job is a last job in said job queue;
when said selected job is determined to not be a last job in said job queue, selecting by said computer system a next job in said queue of jobs as said selected job based on said order-of-operations and element prescriptions in said domain specific language definition and returning operation by said computer system to said step of executing said selected job;
when said selected job is determined to be said last job in said job queue, processing said command translation to create command code and/or configurations that control operation of said at least one target application; and
executing said command code and/or configurations to control operation of said at least one target application.

2. The computerized method of claim 1 wherein said execution of at least one job of said queue of jobs results in a change in said list of elements of said semantic manifold such that operation of said computerized method at least once recursively returns to said step of creating said queue of jobs based on said list of elements as said function of said order-of-operation and element prescriptions in said domain specific language definition and said cardinals of each element in said list of elements of said semantic manifold.

3. The computerized method of claim 1 further comprising checking by said computer system grammar of said list of elements in said semantic manifold prior to performing said step of creating said queue of jobs based on said list of elements as said function of said order-of-operation and element prescriptions in said domain specific language definition and said cardinals of each element in said list of elements of said semantic manifold.

4. The computerized method of claim 1 further comprising validating by said computer system said command translation prior to performing said step of processing said command translation to create said command code and/or configurations that control operation of said at least one target application.

5. The computerized method of claim 1 wherein said natural language command string is input by said user via a keyboard and graphical user interface attached to said computer system.

6. The computerized method of claim 1 wherein said natural language command string is input by said user via a touch screen function of a graphical user interface attached to said computer system.

7. The computerized method of claim 1 wherein said natural language command string is input by said user via a voice command spoken into a microphone attached to said computer system and said voice command is converted to text by voice-to-text conversion software.

8. A natural language translator system that controls at least one target application based upon a natural language command string from a user, said natural language translator system comprising:
a natural language command string receive subsystem that receives said natural language command string from said user;
a parse subsystem that parses said natural language command string to create a list of tokens contained in said natural language command string, each token of said list of tokens being a word or defined phrase in said natural language command string;
a symbol and cardinal determination subsystem that determines a symbol and cardinals for each token in said list of tokens as a function of an analysis of a domain specific language definition stored on said computer system, said symbol being representative of said token and said cardinals being parameters that describe a usage and an order-of-operation for each token;
an element creation subsystem that creates in a semantic manifold an element for each token in said list of tokens such that said semantic manifold contains a list of elements corresponding to said list of tokens, said element being a data structure that stores said symbol and said cardinals of a token,
a job queue creation subsystem that creates a queue of jobs based on elements in said semantic manifold as a function of an order-of-operation and element prescriptions in said domain specific language definition and said cardinals of each element in said list of elements of said semantic manifold, a job being at least one procedure defined in said domain specific language definition declaring operations to create a translation of an element into code and/or configurations that controls said at least one target application;
a first job selection subsystem that selects a first job in said queue of jobs as a selected job based on said order-of-operations and element prescriptions in said domain specific language definition;
a job execution subsystem that executes said selected job in order to create a command translation built from execution of each job in said queue of jobs;
a semantic manifold change detection subsystem that determines if said list of elements in said semantic manifold has changed and, when said list of elements in said semantic manifold is determined to be changed, returns operation to said job queue creation subsystem, and, when said list of elements in said semantic manifold is determined not to be changed, sends operation to a last job determination subsystem;
said last job determination subsystem that determines if said selected job is a last job in said job queue and, when said selected job is determined to not be a last job in said job queue, sends operation to a select next job determination subsystem, and, when said selected job is determined to be said last job in said job queue sends operation to a command translation processing subsystem;
said next job determination subsystem that selects a next job in said queue of jobs as said selected job based on said order-of-operations and element prescriptions in said domain specific language definition and returns operation by said computer system to said job execution subsystem;
said command translation processing subsystem that processes said command translation to create command code and/or configurations that control operation of said at least one target application; and
a command execution subsystem that executes said command code and/or configurations to control operation of said at least one target application.

9. The natural language translator system of claim 8 wherein said job execution subsystem execution of jobs results in a change in said list of elements of said semantic manifold such that operation of said natural language translator system at least once recursively returns operation job queue creation subsystem.

10. The natural language translator system of claim 8 further comprising a grammar check subsystem that checks grammar of said list of elements in said semantic manifold prior to creation of said job queue by said job queue creation subsystem.

11. The natural language translator system of claim 8 further comprising a command translation validation subsystem that validates said command translation prior to processing of said command translation by said command translation processing subsystem.

12. The natural language translator system of claim 8 wherein said natural language command string is input by said user via a keyboard and graphical user interface attached to said computer system.

13. The natural language translator system of claim 8 wherein said natural language command string is input by said user via a touch screen function of a graphical user interface attached to said computer system.

14. The natural language translator system of claim 8 wherein said natural language command string is input by said user via a voice command spoken into a microphone attached to said computer system and said voice command is converted to text by voice-to-text conversion software.
